(19) United States
(12) Patent Application Publication
(10) Pub. No.: US 2020/0050063 A1
(43) Pub. Date: Feb. 13, 2020

(54) LIQUID CRYSTAL DISPLAY DEVICE

(71) Applicant: SHARP KABUSHIKI KAISHA, Sakai City, Osaka (JP)

(72) Inventor: MASAHIRO YOSHIDA, Sakai City, Osaka (JP)

(21) Appl. No.: 16/476,409

(22) PCT Filed: Jan. 5, 2018
(86) PCT No.: PCT/JP2018/000047

§ 371 Date: Jul. 8, 2019

(30) Foreign Application Priority Data
Jan. 12, 2017 (JP) 2017-003533

(51) Int. Cl. G02F 1/1343; G02F 1/1335; G02F 1/1368; G02F 1/1337

(52) U.S. Cl. CPC G02F 1/134363; G02F 1/133514; G02F 1/133512; G02F 1/1368; G02F 2001/133738; G02F 2001/134345; G02F 2201/121; G02F 2201/123; G02F 2201/52; G02F 1/1337

(57) ABSTRACT

The liquid crystal display device of the present invention includes a first substrate, a liquid crystal layer, a second substrate that includes a light-shielding member, multiple sub-pixels each including at least one first liquid crystal domain and at least one second liquid crystal domain, and color filters. The first and second liquid crystal domains are arranged in a color alignment direction. The light-shielding member includes a boundary light-shielding portion at a position corresponding to a boundary between two sub-pixels adjacent in the color alignment direction. One of the two sub-pixels includes two first liquid crystal domains located at respective ends of the sub-pixel and a second liquid crystal domain between the two first liquid crystal domains. The other of the two sub-pixels includes two second liquid crystal domains located at respective ends of the sub-pixel and a the first liquid crystal domain between the two second liquid crystal domains.

### TECHNICAL FIELD

The present invention relates to liquid crystal display devices. The present invention specifically relates to horizontal alignment mode liquid crystal display devices.

### p BACKGROUND ART

Liquid crystal display devices are display devices that utilize a liquid crystal composition for display. A typical display mode thereof is applying voltage to a liquid crystal composition sealed between paired substrates to change the alignment state of liquid crystal molecules in the liquid crystal composition according to the applied voltage, thereby controlling the amount of light transmitted. These liquid crystal display devices, having characteristics such as thin profile, light weight, and low power consumption, have been used in a broad range of fields.

The display modes of liquid crystal display devices include horizontal alignment modes, which control the alignment of liquid crystal molecules by mainly rotating them in a plane parallel to the substrate surfaces. The horizontal alignment modes have received attention because these modes make it easy to achieve wide viewing angle characteristics. For example, the in-plane switching (IPS) mode and the fringe field switching (FFS) mode, both a type of horizontal alignment mode, are widely used in recent liquid crystal display devices for smartphones or tablet terminals.

There is continuing research and development of the horizontal alignment modes for progress in properties such as transmittance to achieve improved display quality. For example, Patent Literature 1 discloses a transverse electric field mode liquid crystal display device including an electrode with bends and having storage capacitance formed on a gate line. In the liquid crystal display device, a conductive line for connecting a counter electrode is disposed only below a disclination line caused by the bends of the electrode. This structure enhances the efficiency of light transmittance to provide a display with high luminance. Patent Literature 2 discloses an image display device where a lenticular lens, a display panel, and a light source are provided in order from a viewer side. When cylindrical lenses of the lenticular lens are arrayed in a horizontal direction, in first-viewpoint pixels and second-viewpoint pixels of the display panel, openings whose sides which intersect with straight lines in the horizontal direction are not parallel to a vertical direction are formed. In addition, a shape of the openings of a pair of pixels mutually adjacent in the vertical direction is made line-symmetric with respect to edges of the pixels extending in the horizontal direction as an axis. This structure can prevent deterioration in display quality due to shading portions of the display panel.

### CITATION LIST

### Patent Literature

Patent Literature 1: JP 2002-122876 A

Patent Literature 2: JP 2005-208567 A

### SUMMARY OF INVENTION

When a transverse electric field mode liquid crystal display device such as a FFS liquid crystal display device is viewed from an oblique direction, color shift, a phenomenon the color changes according to the viewing angle, is caused. For example, when the display device is viewed from the major axis direction of liquid crystal molecules, the display part of the liquid crystal display device may appear bluish. When the display device is viewed from the minor axis direction of liquid crystal molecules, the display part of the liquid crystal display device may appear yellowish. Such color shift can be compensated by a known technique of employing an electrode provided with V-shape slits for the liquid crystal display device.

Unfortunately, the present inventors found through studies that use of the electrode provided with V-shape slits may cause insufficient compensation of color shift in liquid crystal display devices including a pair of substrates whose patterns tend to be significantly misaligned when the substrates are bonded together, such as a display having a curved display surface (also referred to as curved display or curved-surface display) and a large monitor with high definition.

Patent Literature 1 discloses a liquid crystal display device with the following structure in Example 1. The liquid crystal display device includes a region I and a region II. The region I is a region where liquid crystals with voltage applied rotate in one direction and includes eight divisions consisting of four upper divisions and four lower divisions in one pixel. The region II is a region where liquid crystals with voltage applied rotate in the reverse direction and includes four divisions consisting of four central divisions in the pixel. The region I and the region II are different in viewing angle dependence of liquid crystals. Combination of these regions can thus compensate for the viewing angle dependence overall. The viewing angle dependence is minimized by adjusting the line widths and line lengths of the pixel electrode and the counter electrode such that the area of the region I substantially equals the area of the region II. Patent Literature 1 thus discusses the viewing angle dependence.

Unfortunately, the technique disclosed in Patent Literature 1 still causes insufficient compensation of color shift in liquid crystal display devices including a pair of substrates whose patterns tend to be significantly misaligned, such as curved displays and large monitors with high definition. Patent Literature 1 fails to disclose a technique for sufficiently compensating for such color shift.

Patent Literature 2 discloses no technique for compensating for color shift.

The present invention has been made under the current situation in the art and aims to provide a liquid crystal display device capable of compensating for color shift even when the device includes a pair of substrates whose patterns are significantly misaligned.

### Solution to Problem

The present inventors made various studies on techniques for compensating for color shift even in liquid crystal display devices including a pair of substrates whose patterns tend to be significantly misaligned when the substrates are bonded together, such as curved displays and large monitors with high definition. The present inventors then found a structure in which, in two adjacent sub-pixels with a light-shielding member in between, first liquid crystal domain(s) and second liquid crystal domain(s) which have different alignment directions from each other are arranged in a certain order. This structure was found to suppress the change in difference between the aperture ratio of the first liquid crystal domain(s) and the aperture ratio of the second liquid crystal domain(s). Thereby, the color shift can be compensated even when a pair of substrates has significantly misaligned patterns. The inventors thus successfully achieved the above object, arriving at the present invention.

In other words, an aspect of the present invention may be a liquid crystal display device including: a first substrate provided with a sub-pixel electrode and a common electrode; a liquid crystal layer containing liquid crystal molecules; a second substrate that faces the first substrate through the liquid crystal layer and includes a light-shielding member; multiple pixels each including multiple sub-pixels each including at least one first liquid crystal domain and at least one second liquid crystal domain, where the liquid crystal molecules align in different directions from each other with voltage applied; and color filters of different colors disposed for the respective sub-pixels, the first liquid crystal domains and the second liquid crystal domains being arranged in a color alignment direction that is a direction the color filters of a same color align, the light-shielding member including a boundary light-shielding portion at a position corresponding to a boundary between two sub-pixels adjacent in the color alignment direction, a first sub-pixel of the two sub-pixels including two first liquid crystal domains located at respective ends of the sub-pixel in the color alignment direction and one second liquid crystal domain between the two first liquid crystal domains, a second sub-pixel of the two sub-pixels including two second liquid crystal domains located at respective ends of the sub-pixel in the color alignment direction and one first liquid crystal domain between the two second liquid crystal domains.

The liquid crystal display device may include a curved display region.

The display region may be curved in the color alignment direction.

In the first sub-pixel, a total area of sub-pixel apertures of the two first liquid crystal domains may equal a total area of a sub-pixel aperture of the second liquid crystal domain, and in the second sub-pixel, a total area of sub-pixel apertures of the two second liquid crystal domains may equal a total area of a sub-pixel aperture of the first liquid crystal domain.

The sub-pixel apertures of the two sub-pixels may be line symmetrical to each other about a straight line running between the two sub-pixels, and with voltage applied, alignment directions of the liquid crystal molecules in the first sub-pixel may be line symmetrical to alignment directions of the liquid crystal molecules in the second sub-pixel about the straight line running between the two sub-pixels.

The first substrate may further include a thin-film transistor connected to the sub-pixel electrode, the light-shielding member may include a channel light-shielding portion that covers a channel of the thin-film transistor, and in the color alignment direction, a distance from an edge of the channel to an edge of the channel light-shielding portion located outside the edge of the channel may be 20 μm or longer.

One of the first liquid crystal domains and the second liquid crystal domains may include the liquid crystal molecules that rotate in a clockwise direction with voltage applied, and the other of the first liquid crystal domains and the second liquid crystal domains may include the liquid crystal molecules that rotate in a counterclockwise direction with voltage applied.

### Advantageous Effects of Invention

The present invention can provide a liquid crystal display device capable of compensating for color shift even when the device includes a pair of substrates whose patterns are significantly misaligned.

### BRIEF DESCRIPTION OF DRAWINGS

FIG. 1 is a schematic plan view of a liquid crystal display device of Embodiment 1.

FIG. 2 is a schematic plan view showing a first substrate of the liquid crystal display device of Embodiment 1.

FIG. 3 is a schematic plan view showing a second substrate of the liquid crystal display device of Embodiment 1.

FIG. 4 is a schematic cross-sectional view of the liquid crystal display device of Embodiment 1.

FIG. 5 includes drawings of a liquid crystal display device of Example 1. FIG. 5 (a) is a schematic perspective view of the liquid crystal display device of Example 1. FIG. 5 (b) is an enlarged schematic plan view showing part (part surrounded by the broken line) of a display region in FIG. 5 (a).

FIG. 6 is a schematic plan view of a liquid crystal display device of Example 2.

FIG. 7 is a schematic plan view showing a first substrate of the liquid crystal display device of Example 2.

FIG. 8 is a schematic plan view showing a second substrate of the liquid crystal display device of Example 2.

FIG. 9 includes drawings of the liquid crystal display device of Example 2. FIG. 9 (a) is a schematic perspective view of the liquid crystal display device of Example 2. FIG. 9(b) is an enlarged schematic plan view showing part (part surrounded by the broken line) of a display region in FIG. 9 (a).

FIG. 10 is a schematic perspective view of a liquid crystal display device of Example 3.

FIG. 11 is a schematic plan view of the liquid crystal display device of Example 3.

FIG. 12 is a schematic plan view of a liquid crystal display device of Comparative Example 1.

FIG. 13 is a schematic plan view of a liquid crystal display device of Comparative Example 2.

### DESCRIPTION OF EMBODIMENTS

Embodiments of the present invention are described below. The embodiments, however, are not intended to limit the scope of the present invention, and modifications can be appropriately made to the design within the scope of the present invention. In the. following description, the same reference symbols are used throughout the drawings to refer to identical elements or elements having similar functions, and repetitive descriptions are omitted. Features described in the embodiments may appropriately be combined or modified within the spirit of the present invention.

### Embodiment 1

The structure of the substrates of a liquid crystal display device of the present embodiment is described with reference to schematic plan views.

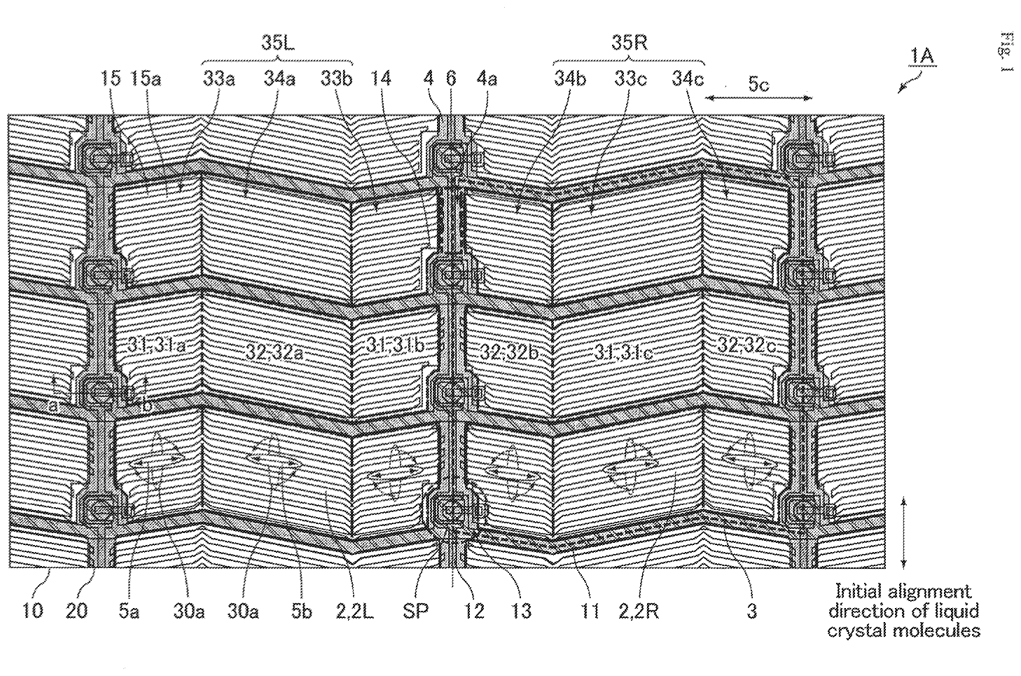

FIG. 1 is a schematic plan view of a liquid crystal display device of Embodiment 1. A liquid crystal display device 1A of the present embodiment includes a first substrate 10, a liquid crystal layer (not shown) containing liquid crystal molecules 30a having negative anisotropy of dielectric constant, and a second substrate 20 that faces the first substrate 10 through the liquid crystal layer and includes a light-shielding member 4. The liquid crystal display device 1A of the present embodiment further includes a backlight (not shown) disposed on the back (on the side remote from the liquid crystal layer) of the first substrate 10. Although the liquid crystal molecules 30a in the present embodiment have negative anisotropy of dielectric constant, the liquid crystal molecules 30a may have positive anisotropy of dielectric constant.

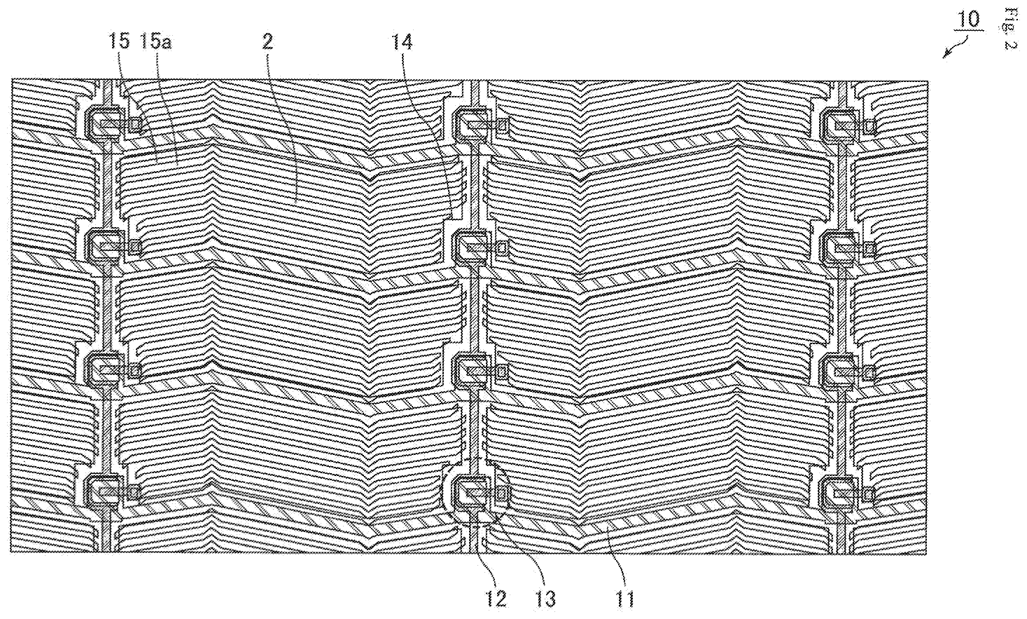

FIG. 2 is a schematic plan view showing the first substrate of the liquid crystal display device of Embodiment 1. The first substrate 10 is an array substrate and is provided with gate lines 11 and data lines 12 intersecting each other as shown in FIG. 2. In the vicinity of the intersections of the gate lines 11 and the data lines 12, thin-film transistors (TFTs) 13 are disposed as switching elements. Each TFT 13 is connected to the corresponding sub-pixel electrode 14. The gate lines 11 each extend, having left and right bends to form a zigzag pattern. The data lines 12 each extend straight upward and downward except for the parts provided with the TFTs 13.

The sub-pixel electrode 14 is disposed for each sub-pixel 2. The sub-pixel electrode 14 is a planar electrode without apertures and is disposed for each region partitioned by the gate lines 11 and the data lines 12. Multiple sub-pixel electrodes 14 are arranged in a matrix. The sub-pixel electrodes 14 may be overlapped with the gate lines 11 and the data lines 12. The sub-pixel 2 means a region corresponding to one sub-pixel electrode 14 and is also referred to as a “dot”. One pixel 3 includes multiple sub-pixels 2 (e.g., three sub-pixels 2 corresponding to R, G, and B). Multiple pixels 3 constitute a display region that provides images. The sub-pixel electrode 14 is paired with a common electrode 15. Voltage application between the sub-pixel electrode 14 and the common electrode 15 drives the liquid crystal molecules 30a in the liquid crystal layer.

The common electrode 15 supplies a constant potential to each sub-pixel 2 and is formed on almost the entire display region (except for apertures 15a for forming a fringe electric field) of the first substrate 10 to cover the gate lines 11 and the data lines 12. The common electrode 15 maybe electrically connected to an external connecting terminal at the periphery (frame region) of the first substrate 10. In each sub-pixel 2, the common electrode 15 is provided with slit apertures 15a, which can generate a fringe electric field. The liquid crystal display device 1A of the present embodiment, which is a FFS mode liquid crystal display device as described above, may be modified into an IPS mode liquid crystal display device by employing a comb teeth-shaped electrode. Each aperture 15a extends parallel to the gate lines 11, having left and right bends to form a zigzag pattern.

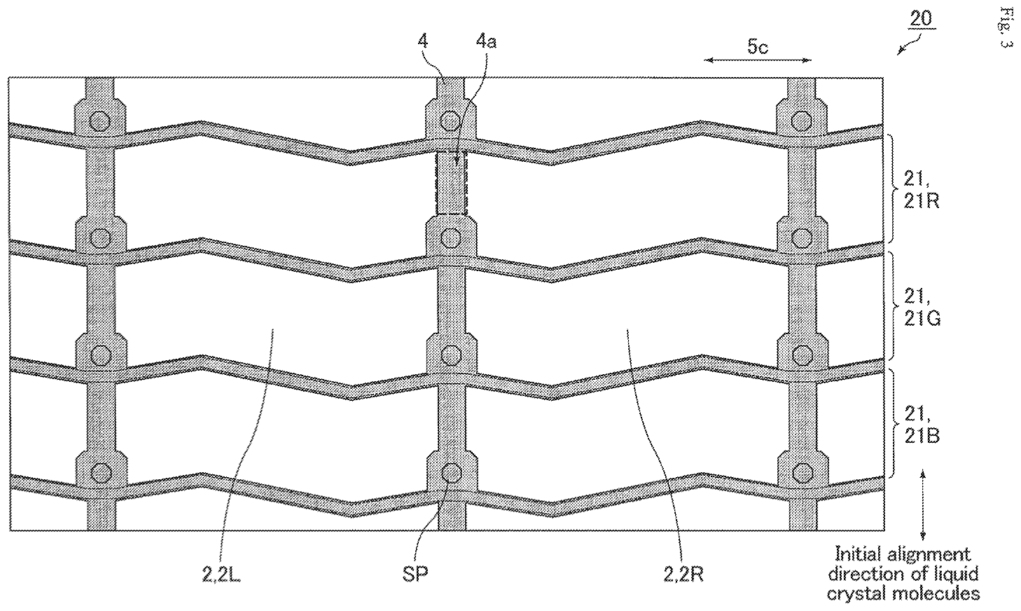

FIG. 3 is a schematic plan view showing the second substrate of the liquid crystal display device of Embodiment 1. As shown in FIG. 3, the second substrate 20 is a counter substrate and includes color filters 21. The color filters 21 may each be a product typically used in the field of liquid crystal display devices.

The second substrate 20 includes red color filters 21R, green color filters 21G, and blue color filters 21B, covering the corresponding sub-pixels 2 arranged in the direction the gate lines 11 extend. The direction in which the color filters 21 of the same color are arranged is also referred to as a color alignment direction 5c. The color filters 21, which include red, green, and blue color filters in the present embodiment, may further include yellow color filters.

The color filters 21, which are disposed in the second substrate 20 in the present embodiment, may be disposed in the first substrate 10.

The second substrate 20 is provided with the light-shielding member 4 that covers the gate lines 11, the data lines 12, and the TFTs 13 in the first substrate 10. The light-shielding member 4 includes boundary light-shielding portions 4a each disposed at a position corresponding to the boundary between two sub-pixels 2 adjacent in the color alignment direction 5c. In other words, a boundary light-shielding portion 4a is disposed for each boundary between two sub-pixels 2 adjacent in the color alignment direction 5c.

The light-shielding member 4 blocks light. The region provided with the light-shielding member 4 always provides black display. The light-shielding member 4 may be a black matrix (BM). The light-shielding member 4 maybe formed from a black photosensitive acrylic resin, for example. Each region surrounded by the light-shielding member 4 (aperture of the light-shielding member 4) corresponds to a sub-pixel aperture. Sub-pixel apertures 35L and 35R, which are apertures of two adjacent sub-pixels 2 (left sub-pixel 2L and right sub-pixel 2R) with the boundary light-shielding portion 4a in between, respectively have a gentle N shape and a gentle reverse N shape, each having bends. The sub-pixel apertures 35L and 35R each include three parallelograms arranged in the color alignment direction 5c (The parallelograms at the sides each include a quadrangular chipped portion in the direction toward the parallelogram in the middle at a position corresponding to the TFT 13. (preferably at a corner)). Although the sub-pixel apertures 35L and 35R may each have a rectangular shape without bends, a bend shape as in the present embodiment effectively enables the two adjacent sub-pixels 2L and 2R to achieve the overall color shift compensation as described below.

At positions corresponding to the TFTs 13 between the first substrate 10 and the second substrate 20 are disposed columnar spacers SP in order to hold a constant gap and form the liquid crystal layer in the gap. For example, the boundary light-shielding portions 4a may be disposed at positions covering regions with the columnar spacers SP, where no rubbing treatment as described later has been performed, in order to shade alignment disorder of the liquid crystal molecules 30a.

The first substrate 10 and/or the second substrate 20 usually include on the liquid crystal layer 30 side surface thereof a horizontal alignment film. The horizontal alignment film aligns the liquid crystal molecules 30a in the vicinity of the film such that their major axes are parallel to the film surface. Furthermore, the liquid crystal molecules 30a, which have been aligned such that their major axes are parallel to the first substrate 10, can be aligned in a certain in-plane direction by performing alignment treatment. The horizontal alignment film is preferably a film having undergone alignment treatment such as photoalignment treatment or rubbing treatment. The initial alignment direction of the liquid crystal molecules 30a is set parallel to the data lines 12 as shown in FIG. 1 when the liquid crystal molecules 30a have negative anisotropy of dielectric constant, and is set perpendicular to the data lines 12 when the liquid crystal molecules 30a have positive anisotropy of dielectric constant. Rubbing treatment is usually performed in the initial alignment direction of the liquid crystal molecules 30a.

The following describes color shift compensation in the liquid crystal display device 1A of the present embodiment.

As shown in FIG. 1, the sub-pixels 2 in the liquid crystal display device 1A of the present embodiment each include first liquid crystal domain(s) 31 and second liquid crystal domain(s) 32 where the liquid crystal molecules 30a align in different directions from each other with voltage applied between the sub-pixel electrodes 14 and the common electrode 15. Preferably, each first liquid crystal domain 31 includes the liquid crystal molecules 30a aligning in a first direction 5a with voltage applied while each second liquid crystal domain 32 includes the liquid crystal molecules 30a aligning in a second direction 5b different from the first direction 5a with voltage applied. The first direction 5a and the second direction 5b each mean the alignment direction of the liquid crystal molecules 30a after response.

The first liquid crystal domains 31 and the second liquid crystal domains 32 are arranged in the color alignment direction 5c which is a direction the color filters of the same color are arranged. In other words, the liquid crystal display device 1A of the present embodiment includes multiple first liquid crystal domains 31 and multiple second liquid crystal domains 32, where the alignment directions of the liquid crystal molecules 30a with voltage applied are different from each other, arranged in the color alignment direction 5c. The first liquid crystal domains 31 and the second liquid crystal domains 32 are alternately arranged in the color alignment direction 5c. These first liquid crystal domains 31 and second liquid crystal domains 32 correspond to the parallelograms of the sub-pixel apertures.

In the present embodiment, the first liquid crystal domains 31 are designed to include the liquid crystal molecules 30a that rotate in a clockwise direction with voltage applied and the second liquid crystal domains 32 are designed to include the liquid crystal molecules 30a that rotate in a counterclockwise direction with voltage applied. The first liquid crystal domains 31 maybe designed to include the liquid crystal molecules 30a that rotate in a counterclockwise direction with voltage applied and the second liquid crystal domains 32 may be designed to include the liquid crystal molecules 30a that rotate in a clockwise direction with voltage applied.

The liquid crystal domain herein means a region defined by a boundary where the liquid crystal molecules 30a do not rotate from the initial alignment direction with voltage, applied. The initial alignment direction of the liquid crystal molecules 30a herein means the alignment direction of the liquid crystal molecules 30a with no voltage applied between the sub-pixel electrodes 14 and the common electrode 15.

The left sub-pixel 2L, which is one of two adjacent sub-pixels 2 with the boundary light-shielding portion 4a in between, includes two first liquid crystal domains 31a and 31b located at respective ends of the left sub-pixel 2L in the color alignment direction 5c and a second liquid crystal domain 32a between the two first liquid crystal domains 31a and 31b.

In other words, in the left sub-pixel 2L, one first liquid crystal domain 31 is divided (preferably halved) into two first liquid crystal domains 31a and 31b such that the first liquid crystal domains 31a and 31b sandwich the second liquid crystal domain 32a in between. The boundary light-shielding portion 4a is thus disposed on the left of the left divided first liquid crystal domain 31a and on the right of the right divided first liquid crystal domain 31b.

The boundary light-shielding portion 4a, the first liquid crystal domains 31a and 31b, and the second liquid crystal domain 32a are arranged as described. Thereby, even when the first substrate 10 and the second substrate 20 are bonded with misalignment to cause displacement of the boundary light-shielding portion 4a in a direction at least including the color alignment direction 5c as a component (e.g., in a left, right, upper right, or lower left direction), at least the second liquid crystal domain 32a between the first liquid crystal domains 31a and 31b is less likely to be influenced by the displacement of the boundary light-shielding portion 4a, which may cause change in the aperture ratio.

Although the two first liquid crystal domains 31a and 31b, being located at the respective ends of the sub-pixel 2, are likely to be influenced by the displacement of the boundary light-shielding portion 4a, they compensate for the aperture ratio each other. Specifically, when the boundary light-shielding portion 4a is displaced in the above direction (the direction at least including the color alignment direction 5c as a component), the aperture ratio of one first liquid crystal domain (e.g., 31a) decreases while the aperture ratio of the other first liquid crystal domain (e.g., 31b) increases.

This structure thus can suppress the change in difference between the aperture ratio of the two first liquid crystal domains 31a and 31b (aperture ratio of the region encompassing the two first liquid crystal domains 31a and 31b) and the aperture ratio of the second liquid crystal domain 32a even when the boundary light-shielding portion 4a is displaced in the above direction. Thereby, color shift can be compensated in each sub-pixel 2.

Similarly, the right sub-pixel 2R, which is the other of the two sub-pixels 2, includes two second liquid crystal domains 32b and 32c located at respective ends of the sub-pixel 2R in the color alignment direction 5c and a first liquid crystal domain 31c between the two second liquid crystal domains 32b and 32c.

The right sub-pixel 2R also can compensate for color shift by the same mechanism as in the left sub-pixel 2L.

Each sub-pixel 2 itself may fail in achieving a sufficient effect of compensating for the aperture ratios of the first liquid crystal domain(s) 31 and the second liquid crystal domain(s) 32 when the substrates are significantly misaligned and the light-shielding part around the TFT 13 is large. The present embodiment is designed such that the two sub-pixels 2 in total can compensate for color shift even in such a case.

In other words, when the light-shielding member 4 is displaced in the above direction, the left sub-pixel 2L and the right sub-pixel 2R in total include:
(1) two first liquid crystal domains 31a and 31b that are likely to be influenced by the misalignment;
(2) one first liquid crystal domain 31c that is less likely to be influenced by the misalignment;
(3) two second liquid crystal domains 32b and 32c that are likely to be influenced by the misalignment; and
(4) one second liquid crystal domain 32a that is less likely to be influenced by the misalignment.

This structure can suppress the change in difference between the aperture ratio of the three first liquid crystal domains 31a, 31b, and 31c (aperture ratio of the region encompassing the three first liquid crystal domains 31a, 31b, and 31c) and the aperture ratio of the three second liquid crystal domains 32a, 32b, and 32c (aperture ratio of the region encompassing the three second liquid crystal domains 32a, 32b, and 32c) even when the light-shielding member 4 is displaced in the above direction.

Thus, the liquid crystal display device 1A of the present embodiment can compensate for color shift even when applied to a liquid crystal display device including a pair of substrates whose patterns tend to be significantly misaligned, such as a curved display with a curved display region or a large monitor with high definition.

The display region is preferably curved in the color alignment direction 5c. This structure achieves a good effect of color shift compensation as well as suppresses the reduction in aperture ratio even when the light-shielding member 4 is disposed between the color filters 21 of different colors for preventing color mixing.

The display region may be entirely or partially curved in the color alignment direction 5c. The latter may include a structure in which the both ends of the display region in the color alignment direction 5c are curved while the middle part excepting the both ends is flat, for example.

The structure of the present embodiment shows a good effect of color shift compensation in a liquid crystal display device with a small dot pitch. In particular, this structure achieves a good effect of color shift compensation in a liquid crystal display device that has a small dot pitch and includes large substrates that tend to be significantly misaligned when being bonded together.

In each sub-pixel 2 of the present embodiment, the total area of the sub-pixel aperture(s) of at least one first liquid crystal domain 31 equals the total area of the sub-pixel aperture(s) of at least one second liquid crystal domain 32. Specifically, as shown in FIG. 1, in the left sub-pixel 2L, the total area of the sub-pixel apertures 33a and 33b of the two first liquid crystal domains 31a and 31b equals the total area of the sub-pixel aperture 34a of the second liquid crystal domain 32a, and in the right sub-pixel 2R, the total area of the sub-pixel apertures 34b and 34c of the two second liquid crystal domains 32b and 32c equals the total area of the sub-pixel aperture 33c of the first liquid crystal domain 31c. In other words, in the left sub-pixel 2L, the sum of the aperture ratios of the two first liquid crystal domains 31a and 31b equals the aperture ratio of the second liquid crystal domain 32a, and in the right sub-pixel 2R, the sum of the aperture ratios of the two second liquid crystal domains 32b and 32c equals the sum of the aperture ratio of the first liquid crystal domain 31c.

Thereby, even when the liquid crystal display device 1A is viewed from an inclined direction, i.e., an up, down, left, right, or oblique viewing direction, the transmittance of the liquid crystal device 1A is less likely to be influenced by the viewing direction. This leads to better compensation of color shift in an oblique direction.

The expression two total areas of sub-pixel apertures are equal to each other herein includes not only the case where the two total areas are perfectly equal to each other but also the case where the two total areas are substantially equal to each other within the range in which the effects of the present invention are achieved. Preferably, one of the two total areas is 85% or more and 120% or less of the other. Similarly, the expression two sums of aperture ratios are equal to each other herein includes not only the case where the two sums are perfectly equal to each other but also the case where the two sums are substantially equal to each other within the range in which the effects of the present invention are achieved. Preferably, one of the two sums is 85% or more and 120% or less of the other.

In the present embodiment, the sub-pixel aperture 35L of the left sub-pixel 2L and the sub-pixel aperture 35R of the right sub-pixel 2R are line symmetrical to each other about the straight line 6 running between the left sub-pixel 2L and the right sub-pixel 2R. In the present embodiment, the TFT 13 of each sub-pixel 2 is disposed substantially on the center line of the data line 12 so that the sub-pixel aperture 35L of the left sub-pixel 2L and the sub-pixel aperture 35R of the right sub-pixel 2R are line symmetrical to each other about the straight line 6.

With voltage applied, the alignment direction of the liquid crystal molecules 30a in the left sub-pixel 2L is line symmetrical to the alignment direction of the liquid crystal molecules 30a in the right sub-pixel 2R about the straight line 6. In other words, the apertures 15a of the common electrode 15 in the left sub-pixel 2L are line symmetrical to the apertures 15a of the common electrode 15 in the right sub-pixel 2R about the straight line 6.

This structure achieves better suppression of the change in difference between the aperture ratio of the three first liquid crystal domains 31a, 31b, and 31c (aperture ratio of the region encompassing the three first liquid crystal domains 31a, 31b, and 31c) and the aperture ratio of the three second liquid crystal domains 32a, 32b, and 32c (aperture ratio of the region encompassing the three second liquid crystal domains 32a, 32b, and 32c) even when the light-shielding member 4 is displaced in a direction at least including the color alignment direction 5c as a component. Thereby, a still better effect of color shift compensation can be achieved.

The expression the sub-pixel aperture 35L of the left sub-pixel 2L and the sub-pixel aperture 35R of the right sub-pixel 2R are line symmetrical to each other about the straight line 6 running between the left sub-pixel 2L and the right sub-pixel 2R herein includes not only the state where the apertures are perfectly line symmetrical to each other but also the state where the apertures are substantially line symmetrical to each other within the range in which the effects of the present invention are achieved.

The expression with voltage applied, the alignment direction of the liquid crystal molecules 30a in the sub-pixel aperture 35L of the left sub-pixel 2L is line symmetrical to the alignment direction of the liquid crystal molecules 30a in the right sub-pixel 2R about the straight line 6 includes not only the state where the aliment directions are perfectly line symmetrical to each other but also the state where the aliment directions are substantially line symmetrical to each other within the range in which the effects of the present invention are achieved.

The expression the apertures 15a of the common electrode 15 in the left sub-pixel 2L are line symmetrical to the apertures 15a of the common electrode 15 in the right sub-pixel 2R about the straight line 6 includes not only the state where the apertures are perfectly line symmetrical to each other but also the state where the apertures are substantially line symmetrical to each other within the range in which the effects of the present invention are achieved.

The present embodiment employs horizontal sub-pixels (also referred to as “horizontal stripe sub-pixels”) in which each sub-pixel 2 has a longer length in the direction the gate lines 11 extend than in the direction the datelines 12 extend. Alternatively, vertical sub-pixels (also referred to as “vertical stripe sub-pixels”) may be employed in which each sub-pixel 2 has a longer length in the direction the datelines 12 extend than in the direction the gate lines 11 extend.

A liquid crystal display device including horizontal stripe sub-pixels includes three times the number of the gate lines 11 and one third the number of data lines 12, compared with a typical liquid crystal display device including vertical stripe sub-pixels. A liquid crystal display device including such horizontal stripe sub-pixels can reduce the number of data drivers to be mounted. Thus, cost reduction can be achieved by this structure in combination with the gate driver monolithic (GDM) technique for monolithically forming gate drivers on a substrate.

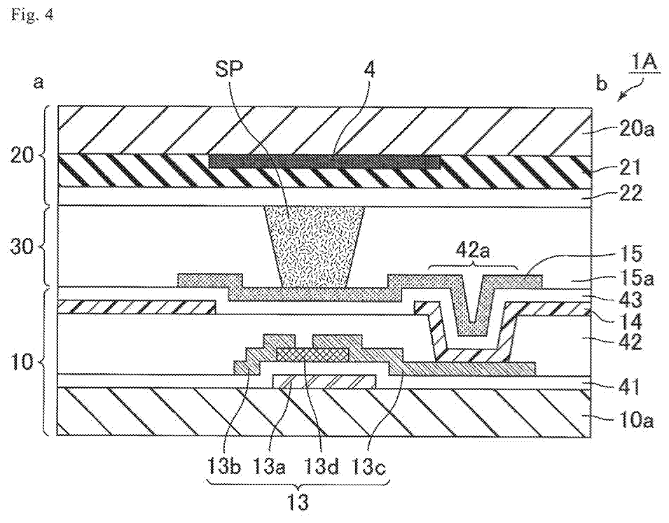

The structure of the liquid crystal display device 1A of the present embodiment is described with reference to a schematic cross-sectional view. FIG. 4 is a schematic cross-sectional view of the liquid crystal display device of Embodiment 1. FIG. 4 shows a cross section taken along the line a-b shown in FIG. 1, i.e., a cross section around the columnar spacer SP.

As shown in FIG. 4, the liquid crystal display device 1A of Embodiment 1 includes the first substrate 10, the second substrate 20, and the liquid crystal layer 30 held between the first substrate 10 and the second substrate 20. The first substrate 10 and the second substrate 20 are usually bonded together with a sealant (not shown) that surrounds the liquid crystal layer 30. The liquid crystal layer 30 is held in a predetermined region by the first substrate 10, the second substrate 20, and the sealant. The sealant may be, for example, an epoxy resin containing inorganic or organic filler and a curing agent.

The first substrate 10 is provided with a first polarizer (not shown), an insulating substrate 10a, the gate lines 11, the data lines 12, a first insulating film 41 disposed between the gate lines 11 and the data lines 12, the thin-film transistors (TFTs) 13 connected to the corresponding gate lines 11 and data lines 12, a second insulating film 42, sub-pixel electrodes 14 connected to the corresponding TFTs 13, a third insulating film 43, and the common electrode 15 provided with the apertures 15a. The TFTs 13, the second insulating film 42, the sub-pixel electrodes 14, the third insulating film 43, and the common electrode 15 are disposed in the stated order toward the liquid crystal layer 30.

The sub-pixel electrodes 14 and the common electrode 15 are stacked via the third insulating film 43. The sub-pixel electrodes 14 are disposed under the apertures 15a in the common electrode 15. This structure enables generation of a fringe electric field around the apertures 15a in the common electrode 15 by a potential difference between the sub-pixel electrodes 14 and the common electrode 15. The positions of the sub-pixel electrodes 14 and the common electrode 15 may be switched. In other words, although FIG. 4 shows the stacking structure in which the common electrode 15 is disposed closer to the liquid crystal layer 30 via the horizontal alignment film (not shown), the sub-pixel electrodes 14 may be disposed closer to the liquid crystal layer 30 via the horizontal alignment film (not shown). In this case, the apertures 15a are formed not in the common electrode 15 but in the sub-pixel electrodes 19.

Each TFT 13 includes a gate electrode 13a, a source electrode 13b, a drain electrode 13c, and a semiconductor layer 13d. The gate electrode 13a of the TFT 13 is made as a protrusion of the gate line 11. The source electrode 13b of the TFT 13 is part of the corresponding data line 12. The TFT 13 is connected to the gate line 11 and the data line 12. The drain electrode 13c of the TFT 13 is connected to the corresponding sub-pixel electrode 14.

The sub-pixel electrode 14 is connected to the drain electrode 13c of the TFT 13 through a contact hole 42a formed in the second insulating film 42. The third insulating film 43 is disposed between the sub-pixel electrode 14 and the common electrode 15. The gate electrode 13a and the semiconductor layer 13d are overlapped with each other via the first insulating film (gate insulator) 41.

The first insulating film (gate insulator) 41 and the third insulating film 43 may each be, for example, an inorganic film (relative permittivity ϵ=5 to 7) such as a silicon nitride (SiNx) or silicon oxide (SiO₂) film or a multilayer film thereof.

The second insulating film 42 may include an inorganic film and an organic film stacked on the inorganic film. The inorganic film is preferably an inorganic film (relative permittivity ϵ=5 to 7) such as a silicon nitride (SiNx) or silicon oxide (SiO₂) film, or a multilayer film thereof, for example. The organic film is preferably a film having a lower relative permittivity (relative permittivity ϵ=3 to 4) than an inorganic film, such as a photosensitive acrylic resin film.

The source electrode 13b and the drain electrode 13c of the TFT 13 are formed directly on the semiconductor layer 13d without a contact hole penetrating an insulating film. The source electrode 13b is connected to the drain electrode 13c via the semiconductor layer 13d. A scanning signal input to the gate electrode 13a through the gate line 11 controls turning on/off of the current flowing through the semiconductor layer 13d, and transfer of a data signal to be input through the data line 12 to the source electrode 13b, the semiconductor layer 13d, the drain electrode 13c, and the sub-pixel electrode 14 in the stated order.

The gate lines 11 and the data lines 12 can be formed by forming a single or multiple layers of a metal such as titanium, aluminum, molybdenum, copper, or chromium, or an alloy thereof by a technique such as sputtering, and patterning the layer(s) by a technique such as photolithography.

The gate electrode 13a, the source electrode 13b, and the drain electrode 13c constituting the TFT 13 can be formed by forming a single or multiple layers of a metal such as titanium, aluminum, molybdenum, copper, or chromium, or an alloy thereof by a technique such as sputtering, and patterning the layer (s) by a technique such as photolithography.

The semiconductor layer 13d of the TFT 13 includes, for example, a high-resistance semiconductor layer formed from a material such as amorphous silicon or polysilicon, and a low-resistance semiconductor layer formed from a material such as n+ amorphous silicon obtained by doping amorphous silicon with an impurity such as phosphorus. The semiconductor layer 13d may be formed from an oxide semiconductor such as zinc oxide. The shape of the semiconductor layer 13d can be determined by forming a layer by a technique such as plasma-enhanced chemical vapor deposition (PECVD) and patterning the layer by a technique such as photolithography.

The conductive lines and electrodes, including the gate line 11 and the data line 12 and the gate electrode 13a, the source electrode 13b, and the drain electrode 13c constituting the TFT 13 can be formed using the same material in the same step as long as they are formed in the same layer. This increases the production efficiency.

The sub-pixel electrodes 14 and the common electrode 15 can be formed by forming a single or multiple layers of a transparent conductive material such as indium tin oxide (ITO), indium zinc oxide (IZO), zinc oxide (ZnO), or tin oxide (SnO), or an alloy thereof by a technique such as sputtering, and patterning the layer(s) by a technique such as photolithography.

The second substrate 20 includes a stack of a second polarizer (not shown), an insulating substrate 20a, the light-shielding member 4, the color filters 21, an overcoat layer 22, and the columnar spacers SP in the stated order toward the liquid crystal layer 30. The overcoat layer 22 flattens the liquid crystal layer 30 side surface of the second substrate 20 and may be, for example, an organic film (dielectric constant ϵ=3 to 4).

The first polarizer and the second polarizer are each an absorptive polarizer and are arranged in the crossed Nicols where the polarization axes thereof are perpendicular to each other.

The insulating substrates 10a and 20a may each be any transparent substrate such as a glass substrate or a plastic substrate.

The liquid crystal layer 30 contains a liquid, crystal composition. The liquid crystal display device 1A of Embodiment 1 applies voltage to the liquid crystal layer 30 to change the alignment state of the liquid crystal molecules in the liquid crystal composition in response to the applied voltage, thereby controlling the transmission amount of light.

Although not shown in FIG. 4 or the like, a horizontal alignment film is usually disposed on the liquid crystal layer 30 side surface of the first substrate 10 and/or the second substrate 20, as mentioned above. The horizontal alignment film may be formed from an inorganic material or an organic material.

The liquid crystal display device 1A may further include members such as optical films, including a retardation film, a viewing angle-increasing film, and a luminance-increasing film; external circuits, including a tape-carrier package (TCP) and a printed circuit board (PCB); and a bezel (frame), in addition to the first substrate 10, the second substrate 20, and the liquid crystal layer 30. These members may be any members that are usually used in the field of liquid crystal display devices. The detailed description for each of these additional members is therefore not provided herein.

The following describes the operation of the liquid crystal display device 1A.

With no voltage applied between the sub-pixel electrodes 14 and the common electrode 15, no electric field is generated in the liquid crystal layer 30, and the liquid crystal molecules are aligned parallel to the first substrate 10. The term “parallel” as used herein encompasses not only the completely parallel state but also a state equated as the completely parallel State (substantially parallel state) in the art. The pre-tilt angle (angle of inclination in the off state) of liquid crystal molecules is preferably smaller than 3°, more preferably smaller than 1°, from the surface of the first substrate 10.

The initial alignment direction of the liquid crystal molecules is parallel to the polarization axis of one of the first polarizer and the second polarizer, and the first polarizer and the second polarizer are in crossed Nicols. The liquid crystal display device 1A with no voltage applied therefore does not transmit light and provides black display (normally black mode).

With voltage applied between the sub-pixel electrodes 14 and the common electrode 15, an electric field is generated in the liquid crystal layer 30 according to the magnitude of the voltage applied between the sub-pixel electrodes 14 and the common electrode 15. Specifically, the structure in which the common electrode 15 is disposed closer to the liquid crystal layer 30 than the sub-pixel electrodes 14 and is provided with the apertures 15a generates a fringe electric field around the apertures 15a. The liquid crystal molecules rotate according to the electric field to change the alignment direction thereof from the initial alignment direction to the alignment direction with voltage applied. Thereby, the liquid crystal display device 1A with voltage applied transmits light to provide white display.

An embodiment of the present invention has been described above. Each and every matter described above is applicable to all the aspects of the present invention.

The present invention is described in more detail with reference to examples and comparative examples. The examples, however, are not intended to limit the present invention.

### EXAMPLE 1

A liquid crystal display device of Example 1 is a specific example of the aforementioned liquid crystal display device 1A of Embodiment 1 and has the following structure.

The liquid crystal display device 1A of Example 1 is a FFS mode liquid crystal display device having the aforementioned structure shown in FIG. 1 to FIG. 4. The liquid crystal display device 1A of Example 1 had a sub-pixel pitch of 210 μm>70 μm and included the liquid crystal layer 30 containing negative liquid crystal molecules (liquid crystal molecules having negative anisotropy of dielectric constant) whose initial alignment direction was set parallel to the data lines 12.

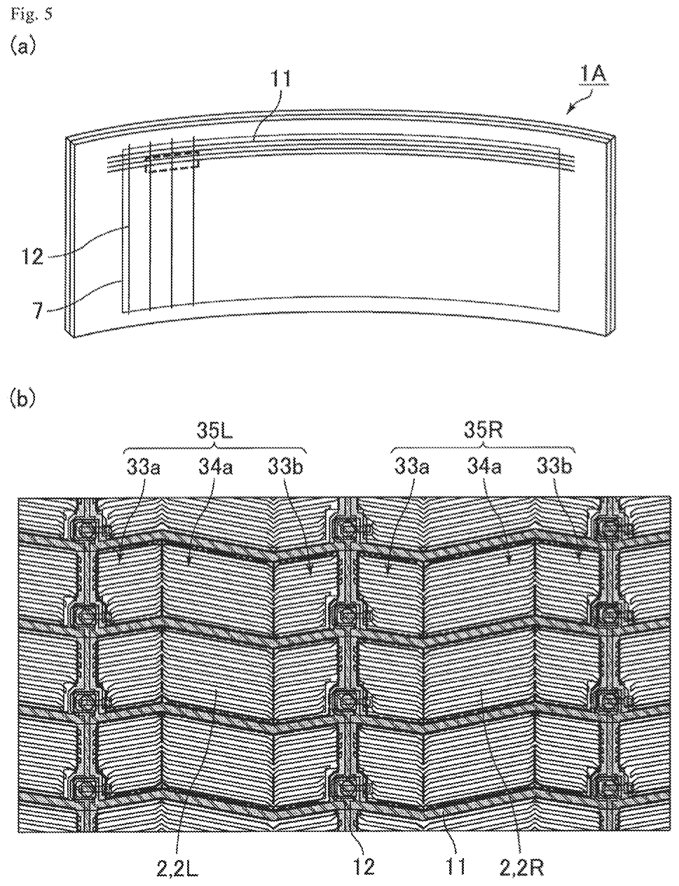

FIG. 5 includes drawings of the liquid crystal display device of Example 1. FIG. 5 (a) is a schematic perspective view of the liquid crystal display device of Example 1. FIG. 5(b) is an enlarged schematic plan view showing part (part surrounded by the broken line) of a display region in FIG. 5 (a). The liquid crystal display device 1A of Example 1 is a curved display as shown in FIG. 5. The liquid crystal display device 1A of Example 1 had a size of 33 inches and a variant shape (3840×1080 sub-pixels, which correspond to the size two full high definition (FHD) screens are horizontally arranged) and included 1080×3 gate lines 11 and 3840 data lines 12. FIG. 5 (a) does not show external mounting members such as a printed circuit and a semiconductor chip.

The liquid crystal display device 1A of Example 1 had a display region 7 having a length in the long side direction of about 806 mm. The sub-pixels 2 were arranged such that the long side direction of the sub-pixels 2, i.e., the color alignment direction 5c, corresponded to the long side direction of the display region 7.

In the liquid crystal display device 1A of Example 1, the display region 7 had a curvature radius of 2000 mm, and the first substrate 10 and the second substrate 20 each had a thickness of 0.1 mm. The liquid crystal display device 1A of Example 1 was curved in the long side direction with the second substrate 20 made inside (viewer's side).

The color filters 21 disposed in the second substrate 20 of the liquid crystal display device 1A of Example 1 were formed in a stripe pattern in the curved direction of the display region 7 in order to avoid the following disadvantage. The light-shielding member 4 is preferred to be disposed between the color filters 21 of different colors for preventing color mixing. However, if the color filters 21 are arranged to form a stripe pattern in the direction perpendicular to the direction the first substrate 10 and the second substrate 20 are more significantly misaligned (the curved direction of the display region 7), the aperture ratio considerably decreases. If 90 degree-rotated sub-pixels 2 are supposed to be disposed in the display region 7 in Example 1, for example, the width of the light-shielding member 4 covering the gate lines 11 needs to be increased by about 20 μm from the width thereof in Example 1, which is 8 μm.

The first substrate 10 and the second substrate 20 of the liquid crystal display device 1A of Example 1 were assumed to be bonded with a misalignment amount of 5 μm in up or down direction and/or in a left or right direction. The aperture ratios of the respective liquid crystal domains and the difference between the aperture ratios of the respective liquid crystal domains were estimated. Specifically, an estimation was made for the aperture ratio of the two first liquid crystal domains 31a and 31b (liquid crystal domains where the liquid crystal molecules rotate in a clockwise direction) and for the aperture ratio of the second liquid crystal domain 32a (liquid crystal domain where the liquid crystal molecules rotate in a counterclockwise direction) in the left sub-pixel 2L of two sub-pixels 2 adjacent in the color alignment direction 5c. Then, the difference between the two aperture ratios was calculated. Similarly, an estimation was made for the aperture ratio of the two second liquid crystal domains 32b and 32c (liquid crystal domains where the liquid crystal molecules rotate in a counterclockwise direction) and for the aperture ratio of the first liquid crystal domain 31c (liquid crystal domain where the liquid crystal molecules rotate in a clockwise direction) in the right sub-pixel 2R of the two adjacent sub-pixels 2. Then, the difference between the two aperture ratios was calculated.

In order to study the compensation effect of the left sub-pixel 2L and the right sub-pixel 2R in total, an estimation was made for the aperture ratio of the three first liquid crystal domains 31a, 31b, and 31c and for the aperture ratio of the three second liquid crystal domains 32a, 32b, and 32c. Then, the difference between the two aperture ratios was calculated. Table 1 Shows the results. The aperture ratios were estimated as follows. Using 2D computer-aided design (CAD) software, a drawing without misalignment of the, second substrate 2.0 with respect to the first substrate 10 and drawings with misalignment thereof were prepared. The areas of the sub-pixel apertures 33a, 33b, and 33c of the first liquid crystal domains and the areas of the sub-pixel apertures 34a, 34b, and 34c of the second liquid crystal domains were measured, whereby the aperture ratios were estimated. Specifically, a drawing without misalignment of the second substrate 20 with respect to the first substrate 10, which was used as a reference, and eight drawings with misalignment, including “a drawing with a misalignment amount to the right of 5 μm”, “a drawing with a misalignment amount to the left of 5 μm”, and “a drawing with a misalignment amount to the left of 5 μm and to the up of 5 μm”, compared with the reference were prepared. In each drawing, the areas of the sub-pixel apertures 33a, 33b, and 33c of the first liquid crystal domains and the areas of the sub-pixel apertures 34a, 34b, and 34c of the second liquid crystal domains were measured, whereby the aperture ratios were estimated. The measurement was made using an area measurement function of the CAD software. The terms “up, down, left, and/or right” representing misalignment directions herein each indicate a misalignment direction of the second substrate with respect to the first substrate.

TABLE 1

| | | | | | | | Total of left sub-pixel | | |
|---|---|---|---|---|---|---|---|---|---|
| | Left sub-pixel | | | Right sub-pixel | | | and right sub-pixel | | |
| | Aperture ratio (%) | | | Aperture ratio (%) | | | Aperture ratio (%) | | |
| | | (Counter- | | (Counter- | | | | (Counter- | |
| | | clock- | | clock- | | | | clockwise | |
| | (Clockwise | wise | | wise | (Clockwise | | (Clockwise | rotation) | |
| Pattern | rotation) | rotation) | | rotation) | rotation) | | rotation) | Second | |
| misalignment | First | Second | Aperture | Second | First | Aperture | First liquid | liquid | Aperture |
| between | liquid | liquid | ratio | liquid | liquid | ratio | crystal | crystal | ratio |
| first substrate | crystal | crystal | difference | crystal | crystal | difference | domain | domain | difference |
| and second | domain | domain | (percentage | domain | domain | (percentage | 31a, | 32a, | (percentage |
| substrate | 31a, 31b | 32a | point) | 32b, 32c | 31c | point) | 31b, 31c | 32b, 32c | point) |
| 0 μm | 39.7 | 39.5 | 0.2 | 39.7 | 39.5 | 0.2 | 39.6 | 39.6 | 0.0 |
| (no | | | | | | | | | |
| misalignment) | | | | | | | | | |
| Right: 5 μm | 39.5 | 39.5 | 0.1 | 39.6 | 39.4 | 0.1 | 39.5 | 39.5 | 0.0 |
| Left: 5 μm | 39.4 | 39.4 | 0.0 | 39.4 | 39.5 | 0.0 | 39.4 | 39.4 | 0.0 |
| Up: 5 μm | 37.1 | 37.0 | 0.2 | 37.0 | 37.0 | 0.1 | 37.1 | 37.0 | 0.1 |
| Down: 5 μm | 37.2 | 36.9 | 0.4 | 37.3 | 36.9 | 0.4 | 37.1 | 37.1 | 0.0 |
| Right: 5 μm + | 37.6 | 36.4 | 1.2 | 36.5 | 37.6 | 1.1 | 37.6 | 36.4 | 1.1 |
| Up: 5 μm | | | | | | | | | |
| Left: 5 μm + | 37.5 | 36.3 | 1.2 | 36.5 | 37.5 | 0.9 | 37.5 | 36.4 | 1.1 |
| Down: 5 μm | | | | | | | | | |
| Right: 5 μm + | 36.5 | 37.5 | 0.9 | 37.5 | 36.3 | 1.2 | 36.4 | 37.5 | 1.1 |
| Down: 5 μm | | | | | | | | | |
| Left: 5 μm + | 36.4 | 37.6 | 1.2 | 37.4 | 36.4 | 1.0 | 36.4 | 37.5 | 1.1 |
| Up: 5 μm | | | | | | | | | |

### COMPARATIVE EXAMPLE 1

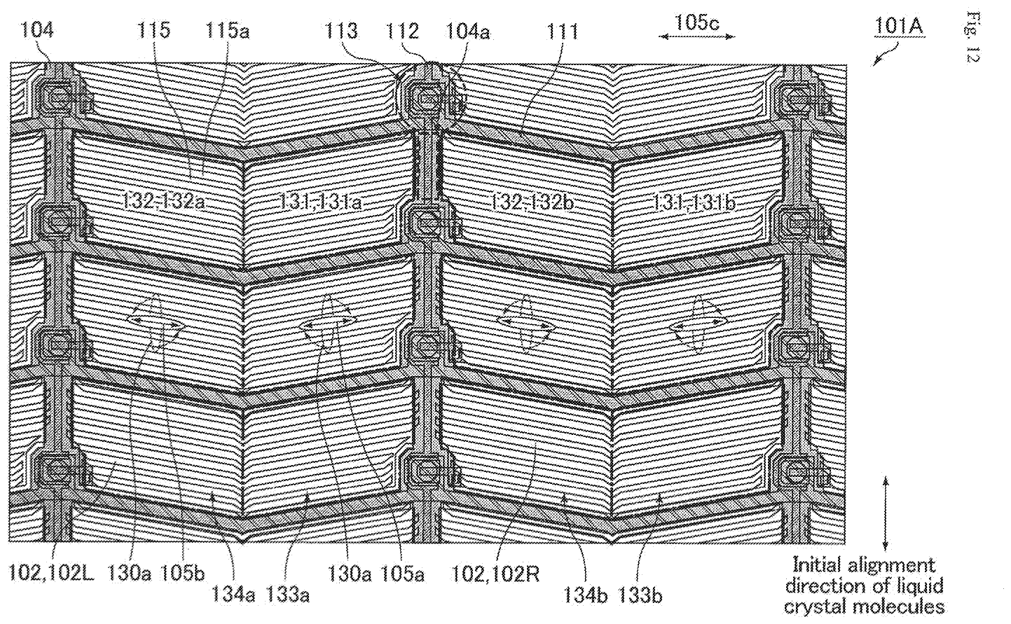

FIG. 12 is a schematic plan view of a liquid crystal display device of Comparative Example 1. A liquid crystal display device 101A of Comparative Example 1 has the same structure as the liquid crystal display device 1A of Example 1 except for the shape of the sub-pixels and the shape of the slits in the common electrode, which is changed into a V shape. Specifically, the liquid crystal display device 101A of Comparative Example 1 is a FFS mode liquid crystal display device 101A that includes a first substrate provided with sub-pixel electrodes and a common electrode, a liquid crystal layer containing negative liquid crystal molecules, and a second substrate including the light-shielding member 104 consisting of a black matrix in the stated order.

The liquid crystal display device 101A of Comparative Example 1 included liquid crystal molecules whose initial alignment direction was set parallel to data lines 112, gate lines 111 disposed in the direction intersecting the data lines 112, and thin-film transistors (TFTs) 113 as switching elements disposed around the respective intersections of the gate lines 111 and the data lines 112. A common electrode 115 was provided with slit apertures 115a. With voltage applied, the alignment direction of liquid crystal molecules 130a in a sub-pixel 102L, which is a left sub-pixel of two sub-pixels 102 adjacent in a color alignment direction 105c, was line symmetrical to the alignment direction of the liquid crystal molecules 130a in a sub-pixel 102R, which is a right sub-pixel of the two adjacent sub-pixels 102, about a straight line running between the two adjacent sub-pixels 102.

The liquid crystal display device 101A of Comparative Example 1 included first liquid crystal domains 131, 131a, and 131b where the liquid crystal molecules 130a aligned in a first direction 105a with voltage applied and second liquid crystal domains 132, 132a, and 132b where the liquid crystal molecules 130a aligned in a second direction 105b different from the first direction 105a with voltage applied. The sub-pixels 102 had a horizontal stripe pattern, and the sub-pixel pitch was 210 μm×70 μm. The first liquid crystal domains 131, 131a, and 131b correspond to a region where the liquid crystal molecules rotate in a clockwise direction with voltage applied, and the second liquid crystal domains 132, 132a, and 132b correspond to a region where the liquid crystal molecules rotate in a counterclockwise direction with voltage applied. In the left sub-pixel 102L and the right sub-pixel 102R, the areas of sub-pixel apertures 133a and 133b of the first liquid crystal domains were respectively made the same as the areas of sub-pixel apertures 134a and 134b of the second liquid crystal domains.

Similarly to the case of the liquid crystal display device 1A of Example 1, the first substrate and the second substrate of the liquid crystal display device 101A of Comparative Example 1 were assumed to be bonded with a misalignment amount of 5 μm in the up or down direction and/or in the left or right direction. The aperture ratios of the respective liquid crystal domains and the difference between the aperture ratios of the respective liquid crystal domains were estimated. Specifically, an estimation was made for the aperture ratio of the first liquid crystal domain 131a (liquid crystal domain ,where the liquid crystal molecules rotate in a clockwise direction) and for the aperture ratio of the second liquid crystal domain 132a (liquid crystal domain where the liquid crystal molecules rotate in a counterclockwise direction) in the left sub-pixel 102L of two sub-pixels 102 adjacent in the color alignment direction 105c. Then, the difference between the two aperture ratios was calculated. Similarly, an estimation was made for the aperture ratio of the first liquid crystal domain 131b (liquid crystal domain where the liquid crystal molecules rotate in a clockwise direction) and for the aperture ratio of the second liquid crystal domain 132b (liquid crystal domain where the liquid crystal molecules rotate in a counterclockwise direction) in the right sub-pixel 102R of the two adjacent sub-pixels 102. Then, the difference between the two aperture ratios was calculated.

In order to study the compensation effect of the left sub-pixel 102L and the right sub-pixel 102R in total, an estimation was made for the aperture ratio of the two first liquid crystal domains 131a and 131b and for the aperture ratio of the two second liquid crystal domains 132a and 132b. Then, the difference between the two aperture ratios was calculated. Table 2 shows the results.

TABLE 2

| | | | | | | | Total of left sub-pixel | | |
|---|---|---|---|---|---|---|---|---|---|
| | Left sub-pixel | | | Right sub-pixel | | | and right sub-pixel | | |
| | Aperture ratio (%) | | | Aperture ratio (%) | | | Aperture ratio (%) | | |
| | (Counter- | | | (Counter- | | | (Counter- | (Clock- | |
| | clock- | (Clock- | | clock- | (Clock- | | clockwise | wise | |
| | wise | wise | | wise | wise | | rotation) | rotation) | |
| Pattern | rotation) | rotation) | | rotation) | rotation) | | Second | First | |
| misalignment | Second | First | Aperture | Second | First | Aperture | liquid | liquid | Aperture |
| between | liquid | liquid | ratio | liquid | liquid | ratio | crystal | crystal | ratio |
| first substrate | crystal | crystal | difference | crystal | crystal | difference | domain | domain | difference |
| and second | domain | domain | (percentage | domain | domain | (percentage | 132a, | 131a, | (percentage |
| substrate | 132a | 131a | point) | 132b | 131b | point) | 132b | 131b | point) |
| 0 μm | 39.5 | 39.6 | 0.1 | 39.5 | 39.6 | 0.1 | 39.5 | 39.6 | 0.1 |
| (no | | | | | | | | | |
| misalignment) | | | | | | | | | |
| Right: 5 μm | 37.7 | 41.3 | 3.6 | 37.7 | 41.3 | 3.6 | 37.7 | 41.3 | 3.6 |
| Left: 5 μm | 41.3 | 37.5 | 3.9 | 41.3 | 37.5 | 3.9 | 41.3 | 37.5 | 3.9 |
| Up: 5 μm | 36.9 | 37.0 | 0.1 | 36.9 | 37.0 | 0.1 | 36.9 | 37.0 | 0.1 |
| Down: 5 μm | 37.1 | 37.1 | 0.0 | 37.1 | 37.1 | 0.0 | 37.1 | 37.1 | 0.0 |
| Right: 5 μm + | 34.6 | 39.2 | 4.6 | 34.6 | 39.2 | 4.6 | 34.6 | 39.2 | 4.6 |
| Up: 5 μm | | | | | | | | | |
| Left: 5 μm + | 38.1 | 35.8 | 2.3 | 38.1 | 35.8 | 2.3 | 38.1 | 35.8 | 2.3 |
| Down: 5 μm | | | | | | | | | |
| Right: 5 μm + | 35.9 | 38.1 | 2.1 | 35.9 | 38.1 | 2.1 | 35.9 | 38.1 | 2.1 |
| Down: 5 μm | | | | | | | | | |
| Left: 5 μm + | 39.1 | 34.4 | 4.7 | 39.1 | 34.4 | 4.7 | 39.1 | 34.4 | 4.7 |
| Up: 5 μm | | | | | | | | | |

### [Comparison Between Example 1 and Comparative Example 1]

In the liquid crystal display device 101A of Comparative Example 1, under the assumption that the misalignment of the second substrate with respect to the first substrate was maximum in each of eight directions, including up, down, left, right, upper right, lower right, upper left, and lower, left directions, the difference between the aperture ratio of the first liquid crystal domain 131 and the aperture ratio of the second liquid crystal domain 132 in each sub-pixel 102 was 4.7 percentage points at the maximum.

The difference in aperture ratio between the first liquid crystal domain 131 and the second liquid crystal domain 132 in each sub-pixel 102 is supposed to be caused by the following reason. That is, when a boundary light-shielding portion 104a, which is part of the light-shielding member 109 formed in the second substrate and is disposed at a position corresponding to the boundary between two sub-pixels, is displaced in a left or right direction (color alignment direction), the aperture ratio of a specific liquid crystal domain is increased or reduced. For example, when the aperture ratio of the first liquid crystal domain 131 is increased, the aperture ratio of the second liquid crystal domain 132 is reduced.

Thus, in liquid crystal display devices such as curved displays and large monitors with high definition, color shift compensation may be insufficient even when their electrodes are provided with V-shape slits.

In contrast, in the liquid crystal display device 1A of Example 1, the difference in aperture ratio is 1.2 percentage points at the maximum both in the left sub-pixel 2L and the right sub-pixel 2R, which means the difference in aperture ratio is reduced as compared with the liquid crystal display device 101A of Comparative Example 1 which had a difference in aperture ratio of 4.7 percentage points. This reduction is supposed to be achieved as follows. Even when the boundary light-shielding portion 4a is displaced in the direction at least including the color alignment direction 5c as a component (e.g., in a left, right, upper right, or lower left direction), the two first liquid crystal domains 31a and 31b in the left sub-pixel 2L compensate for each other's aperture ratios. Similarly in the right sub-pixel 2R, the two second liquid crystal domains 32b and 32c compensate for each other's aperture ratios. Accordingly, in spite of the misalignment, the change in difference between the aperture ratio(s) of the first liquid crystal domain(s) 31 and the aperture ratio(s) of the second liquid crystal domain(s) 32 in each sub-pixel 2 can be suppressed, which achieves a good effect of color shift compensation.

Thus, the liquid crystal display device 1A of Example 1 has a smaller difference in aperture ratio than the liquid crystal display device 101A of Comparative Example 1, thereby achieving a better effect of color shift compensation.

The overall difference in aperture ratio of the left sub-pixel 2L and the right sub-pixel 2R, which are line symmetrical to each other about the straight line 6 (or the boundary light-shielding portion 4a) running between the left sub-pixel 2L and the right sub-pixel 2R, is 1.1 percentage points at the maximum, which is below the maximum value, 1.2 percentage points, of the difference in each of the left sub-pixels 2L and the right sub-pixels 2R. In other words, the left sub-pixel 2L and the right sub-pixel 2R in total achieved a better color shift compensation.

In Example 1, the compensation achieved by only one of the two adjacent sub-pixels 2 unfortunately gives an insufficient effect of aperture ratio compensation around the TFT 13 where the light-shielding member 4 is enlarged. In addition, the sub-pixel apertures 35L and 35R each have a bend shape. Thus, the misalignment gives an influence not only on the liquid crystal domains at the respective ends of each sub-pixel 2 in the color alignment direction 5c (the first liquid crystal domains 31a and 31b in the left sub-pixel 2L, the second liquid crystal domains 32b and 32c in the right sub-pixel 2R) but also on the liquid crystal domain in the middle of each sub-pixel 2 in the color alignment direction 5c (the second liquid crystal domain 32a in the left sub-pixel 2L, the first liquid crystal domain 31c in the right sub-pixel 2R), although the influence thereon is not as large as in the liquid crystal domains at the respective ends. Thus, the compensation achieved by one sub-pixel only undesirably gives an insufficient effect of aperture ratio compensation. Here, two adjacent sub-pixels 2, which are line symmetrical to each other, are considered in total. This structure can further suppress the change in difference between the aperture ratio of the first liquid crystal domains 31a, 31b, and 31c and the aperture ratio of the second liquid crystal domains 32a, 32b, and 32c, which is caused by the misalignment between the two substrates, thereby achieving better aperture ratio compensation. Unfortunately, the effect of the structure including two line symmetrical sub-pixels 2 is small in Example 1, which provides a structure slightly influenced by an enlarged region of the light-shielding member 4. The effect of the structure including two line symmetrical sub-pixels is significantly exerted in the case as in the later-described Example 2 where the two substrates are significantly misaligned, i.e., the case where the light-shielding member 4 is locally enlarged around the TFTs 13.

### EXAMPLE 2

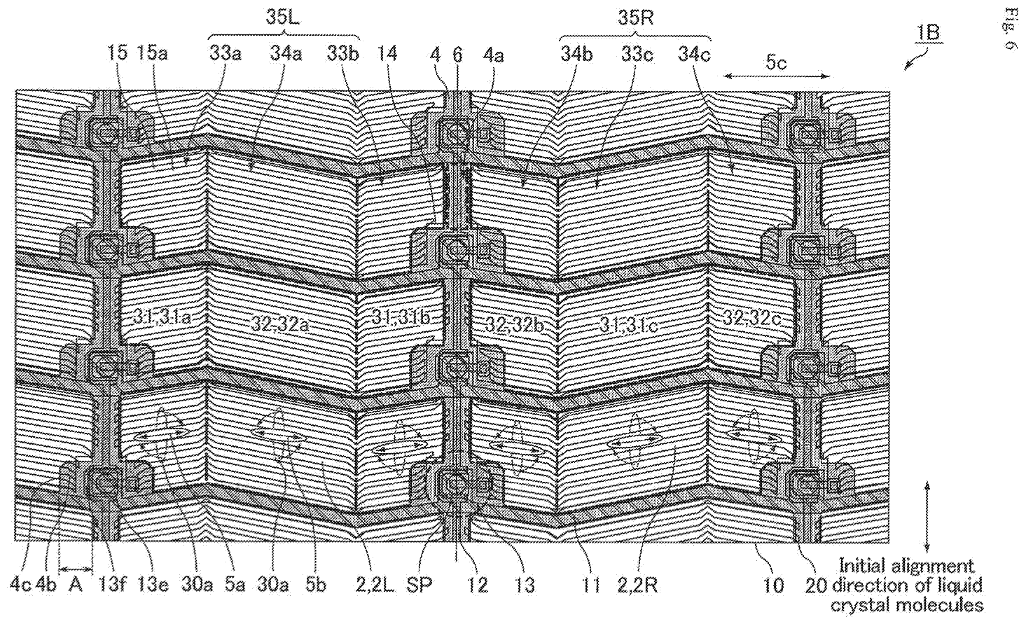

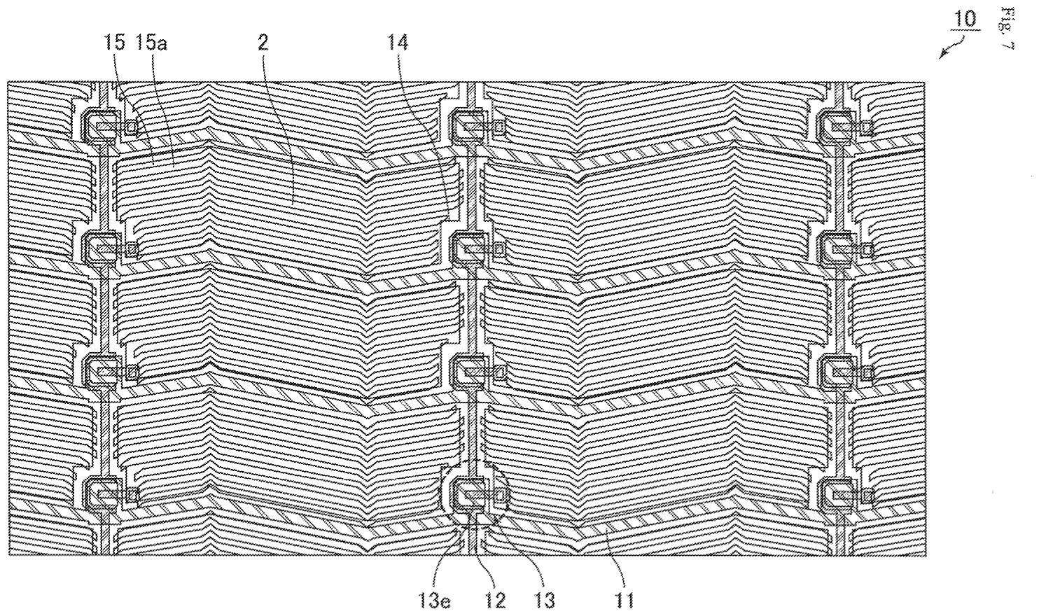

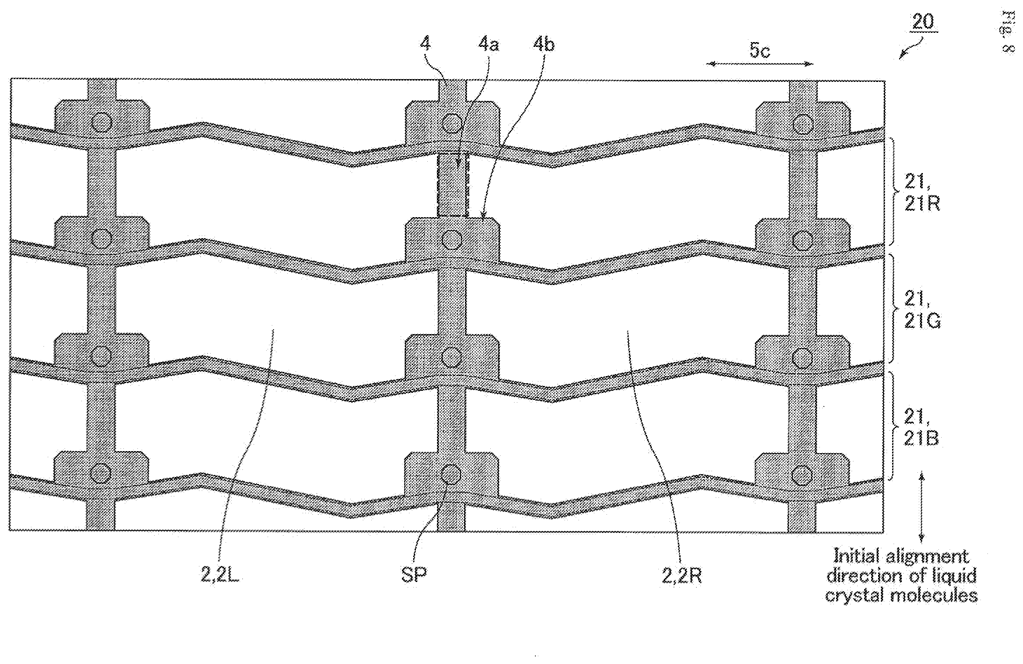

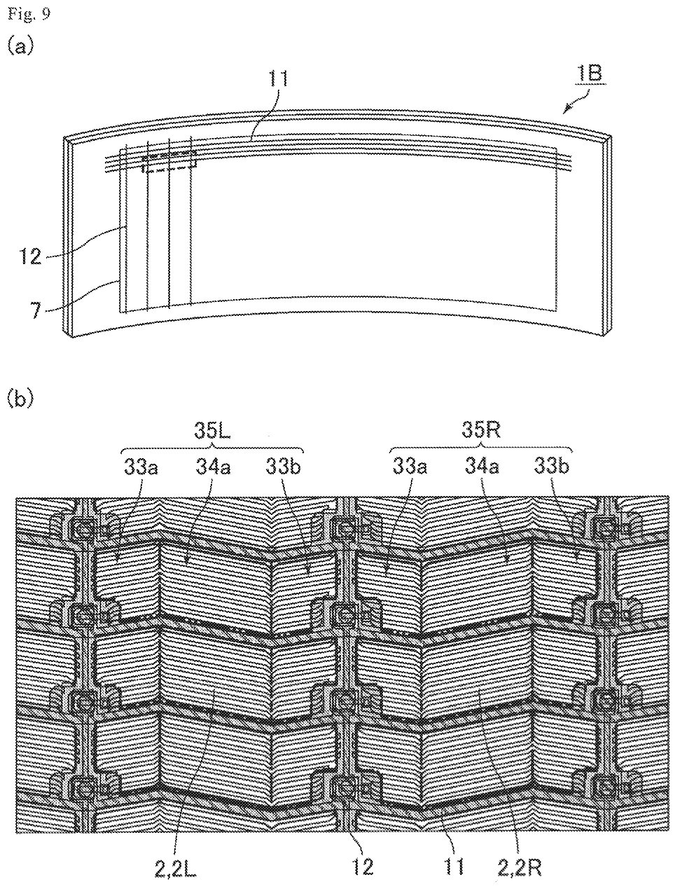

FIG. 6 is a schematic plan view of a liquid crystal display device of Example 2. FIG. 7 is a schematic plan view showing a first substrate of the liquid crystal display device of Example 2. FIG. 8 is a schematic plan view showing a second substrate of the liquid crystal display device of Example 2. FIG. 9 includes drawings of the liquid crystal display device of Example 2. FIG. 9(a) is a schematic perspective view of the liquid crystal display device of Example 2. FIG. 9(b) is an enlarged schematic plan view showing part (part surrounded by the broken line) of a display region in FIG. 9(a).

As shown in FIG. 6 to FIG. 9, a liquid crystal display device 18 of Example 2 has the same structure as the liquid crystal display device 1A of Example 1 except that the parts covering the TFTs 13 of the light-shielding member 4 are enlarged and the parts such as the bend parts of each aperture 15a of the common electrode 15 are slightly adjusted. In other words, the liquid crystal display device 1B of Example 2 was a FFS mode liquid crystal display device having a sub-pixel pitch of 210 μm×70 μm and including the liquid crystal layer 30 containing negative liquid crystal molecules.

The first substrate 10 and the second substrate 20 of the liquid crystal display device 1B of Example 2 were assumed to be bonded with a misalignment amount of 5 μm in the up or down direction and/or 20 μm in the left or right direction. The aperture ratios of the respective liquid crystal domains and the difference between the aperture ratios of the respective liquid crystal domains were estimated in the same manner as in Example 1. Table 3 shows the results.

In the liquid crystal display device 1B of Example 2, in order to prevent external light from being incident on a channel 13e of each TFT 13, the part covering the TFT 13 of the light-shielding member 4 is enlarged by the length corresponding to the increased amount of the misalignment in bonding, as compared with the case in the liquid crystal display device 1A of Example 1. Specifically, in the liquid crystal display device 1B of Example 2, the light-shielding member 4 included channel light-shielding portions 4b each covering the corresponding channel 13e of the TFT 13 and had, in the color alignment direction 5c, a distance A, which is from an edge 13f of the channel 13e to an edge 4c of the channel light-shielding portion 4b located outside the edge 13f, of 20 μm or longer (specifically, 21 μm).

TABLE 3

| | | | | | | | Total of left sub-pixel | | |
|---|---|---|---|---|---|---|---|---|---|
| | Left sub-pixel | | | Right sub-pixel | | | and right sub-pixel | | |
| | Aperture ratio (%) | | | Aperture ratio (%) | | | Aperture ratio (%) | | |
| | | (Counter- | | (Counter- | | | | (Counter- | |
| | (Clock- | clock- | | clock- | (Clock- | | (Clockwise | clockwise | |
| | wise | wise | | wise | wise | | rotation) | rotation) | |
| Pattern | rotation) | rotation) | | rotation) | rotation) | | First | Second | |
| misalignment | First | Second | Aperture | Second | First | Aperture | liquid | liquid | Aperture |
| between | liquid | liquid | ratio | liquid | liquid | ratio | crystal | crystal | ratio |
| first substrate | crystal | crystal | difference | crystal | crystal | difference | domain | domain | difference |
| and second | domain | domain | (percentage | domain | domain | (percentage | 31a, | 32a, | (percentage |
| substrate | 31a, 31b | 32a | point) | 32b, 32c | 31c | point) | 31b, 31c | 32b, 32c | point) |
| 0 μm | 37.7 | 37.8 | 0.1 | 37.7 | 37.8 | 0.1 | 37.8 | 37.8 | 0.0 |
| (no | | | | | | | | | |
| misalignment) | | | | | | | | | |
| Right: 20 μm | 35.3 | 36.2 | 0.9 | 34.6 | 36.1 | 1.5 | 35.7 | 35.4 | 0.3 |
| Left: 20 μm | 34.6 | 36.1 | 1.6 | 35.3 | 36.2 | 0.9 | 35.4 | 35.7 | 0.4 |
| Up: 5 μm | 35.0 | 35.4 | 0.4 | 35.0 | 35.4 | 0.4 | 35.2 | 35.2 | 0.0 |
| Down: 5 μm | 35.9 | 35.3 | 0.6 | 35.9 | 35.3 | 0.6 | 35.6 | 35.6 | 0.0 |
| Right: 20 μm + | 35.1 | 33.4 | 1.7 | 31.9 | 37.3 | 5.4 | 36.2 | 32.7 | 3.5 |
| Up: 5 μm | | | | | | | | | |
| Left: 20 μm + | 34.6 | 33.3 | 1.3 | 33.2 | 37.3 | 4.1 | 35.9 | 33.3 | 2.7 |
| Down: 5 μm | | | | | | | | | |
| Right: 20 μm + | 33.2 | 37.3 | 4.1 | 34.7 | 33.3 | 1.3 | 33.3 | 36.0 | 2.7 |
| Down: 5 μm | | | | | | | | | |
| Left: 20 μm + | 32.0 | 37.3 | 5.3 | 35.0 | 33.4 | 1.6 | 32.7 | 36.2 | 3.5 |
| Up: 5 μm | | | | | | | | | |

### [COMPARATIVE EXAMPLE 2]

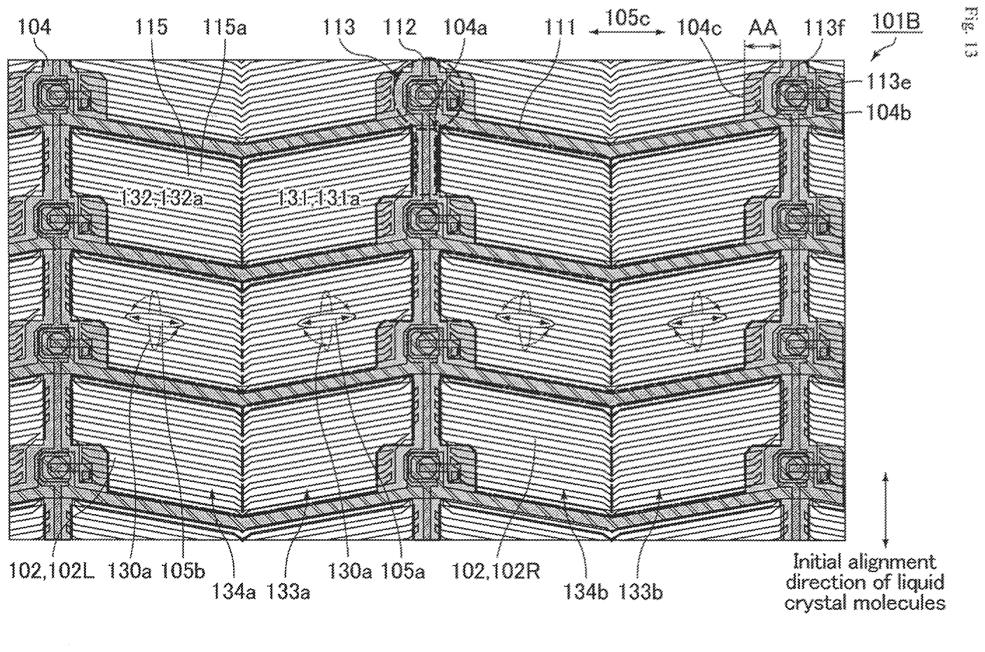

FIG. 13 is a schematic plan view of a liquid crystal display device of Comparative Example 2. A liquid crystal display device 101B of Comparative Example 2 has the same structure as the liquid crystal display device 101A of Comparative Example 1 except that the parts covering the TFTs of the light-shielding member 104 are enlarged. In other words, the liquid crystal display device 101B of Comparative Example 2 was a FFS mode liquid crystal display device having a sub-pixel pitch of 210 μm×70 μm and including a liquid crystal layer containing negative liquid crystal molecules.

The first substrate and the second substrate of the liquid crystal display device 101B of Comparative Example 2 were assumed to be bonded with a misalignment amount of 5 μm in the up or down direction and/or 20 μm in the left or right direction. The aperture ratios of the respective liquid crystal domains and the difference between the aperture ratios of the respective liquid crystal domains were estimated in the same manner as in Example 1. Table 4 shows the results.

In the liquid crystal display device 101E of Comparative Example 2, in order to prevent external light from being incident on a channel 113e of each TFT 113, the part covering the TFT 113 of the light-shielding member 104 is enlarged by the length corresponding to the increased amount of the misalignment in bonding, as compared with the case in the liquid crystal display device 101A of Comparative Example 1. Specifically, in the liquid crystal display device 101E of Comparative Example 2, the light-shielding member 104 included channel light-shielding portions 104b each covering the corresponding channel 113e of the TFT 113 and had, in the color alignment direction 105c, a distance AA, which is from an edge 113f of the channel 113e to an edge 104c of the channel light-shielding portion 104b located outside the edge 113f, of 20 μm or longer (specifically, 21 μm). (0120)

TABLE 4

| | | | | | | | Total of left sub-pixel | | |
|---|---|---|---|---|---|---|---|---|---|
| | Left sub-pixel | | | Right sub-pixel | | | and right sub-pixel | | |
| | Aperture ratio (%) | | | Aperture ratio (%) | | | Aperture ratio (%) | | |
| | (Counter- | | | (Counter- | | | (Counter- | | |
| | clock- | (Clock- | | clock- | (Clock- | | clock- | (Clock- | |
| | wise | wise | | wise | wise | | wise | wise | |
| Pattern | rotation) | rotation) | | rotation) | rotation) | | rotation) | rotation) | |
| misalignment | Second | First | Aperture | Second | First | Aperture | Second | First | Aperture |
| between | liquid | liquid | ratio | liquid | liquid | ratio | liquid | liquid | ratio |
| first substrate | crystal | crystal | difference | crystal | crystal | difference | crystal | crystal | difference |
| and second | domain | domain | (percentage | domain | domain | (percentage | domain | domain | (percentage |
| substrate | 132a | 131a | point) | 132b | 131b | point) | 132a, 132b | 131a, 131b | point) |
| 0 μm | 37.6 | 37.4 | 0.2 | 37.6 | 37.4 | 0.2 | 37.6 | 37.4 | 0.2 |
| (no | | | | | | | | | |
| misalignment) | | | | | | | | | |
| Right: 20 μm | 30.4 | 40.0 | 9.6 | 30.4 | 40.0 | 9.6 | 30.4 | 40.0 | 9.6 |
| Left: 20 μm | 40.1 | 27.6 | 12.5 | 40.1 | 27.6 | 12.5 | 40.1 | 27.6 | 12.5 |
| Up: 5 μm | 34.9 | 34.8 | 0.2 | 34.9 | 34.8 | 0.2 | 34.9 | 34.8 | 0.2 |
| Down: 5 μm | 35.5 | 35.3 | 0.2 | 35.5 | 35.3 | 0.2 | 35.5 | 35.3 | 0.2 |
| Right: 20 μm + | 23.0 | 26.9 | 4.0 | 23.0 | 26.9 | 4.0 | 23.0 | 26.9 | 4.0 |
| Up: 5 μm | | | | | | | | | |
| Left: 20 μm + | 36.9 | 28.9 | 8.1 | 36.9 | 28.9 | 8.1 | 36.9 | 28.9 | 8.1 |
| Down: 5 μm | | | | | | | | | |
| Right: 20 μm + | 29.1 | 36.8 | 7.8 | 29.1 | 36.8 | 7.8 | 29.1 | 36.8 | 7.8 |
| Down: 5 μm | | | | | | | | | |
| Left: 20 μm + | 40.9 | 25.0 | 15.9 | 40.9 | 25.0 | 15.9 | 40.9 | 25.0 | 15.9 |
| Up: 5 μm | | | | | | | | | |

### [Comparison Between Example 2 and Comparative Example 2]

In the liquid crystal display device 101E of Comparative Example 2, under the assumption that the misalignment of the first substrate and the second substrate was maximum in each of eight directions, including up, down, left, right, upper right, lower right, upper left, and lower left directions, the difference between the aperture ratio of the first liquid crystal domain 131 and the aperture ratio of the second liquid crystal domain 132 in each sub-pixel 102 was 15.9 percentage points at the maximum.

The difference in aperture ratio between the first liquid crystal domain 131 and the second liquid crystal domain 132 in each sub-pixel 102 is supposed to be caused by the same reason as in Comparative Example 1. The difference in aperture ratio is increased because, assumedly, the two substrates of the liquid crystal display device 101B of Comparative Example 2 are more significantly misaligned than in Comparative Example 1.

As mentioned above, in liquid crystal display devices such as curved displays and large monitors with high definition, color shift compensation may be insufficient even when their electrodes are provided with V-shape slits.

In contrast, in the liquid crystal display device 1B of Example 2, the difference in aperture ratio is 5.3 percentage points at the maximum in the left sub-pixel 2L and 5.4 percentage points at the maximum in the right sub-pixel 2R, which means the difference in aperture ratio is remarkably reduced as compared with the liquid crystal display device 101B of Comparative Example 2 which had a difference in aperture ratio of 15.9 percentage points.

Thus, the liquid crystal display device 1B of Example 2 has a smaller difference in aperture ratio than the liquid crystal display device 102B of Comparative Example 2, thereby achieving a better effect of color shift compensation. This achievement is considered owing to the same reason as in Example 1 and Comparative Example 1.

The difference in aperture ratio between the first liquid crystal domains and the second liquid crystal domains of the total of the left sub-pixel 2L and the right sub-pixel 2R, which are line symmetrical to each other about the straight line 6 (or the boundary light-shielding portion 4a) running between the left sub-pixel 2L and the right sub-pixel 2R, is 3.5 percentage points at the maximum, which is below the maximum value, 5.4 percentage points, of the difference in the left sub-pixel 2L and the right sub-pixel 2R. In other words, the left sub-pixel 2L and the right sub-pixel 2R in total achieved a better color shift compensation. This achievement is also considered owing to the same reason as in Example 1 and Comparative Example 1.

In the liquid crystal display device 1B of Example 2, the difference in aperture ratio can be more reduced by 1.9 percentage points at the maximum when two adjacent sub-pixels 2 are considered in total than when the two sub-pixels 2 are separately considered. In the liquid crystal display device 1A of Example 1, the difference in aperture ratio can be more reduced by 0.1 percentage points when the two adjacent sub-pixels 2 are considered in total than when the two sub-pixels 2 are separately considered. Thus, when two line symmetrical sub-pixels are considered in total, more effective color shift compensation can be achieved in Example 2 that causes larger misalignment between the two substrates.

The reason for this is assumedly as follows. Example 1 causes small misalignment between two substrates. Thus, even when the light-shielding member 4 is enlarged around each TFT 13 and the sub-pixel apertures 35L and 35R each have a bend shape, each sub-pixel 2 can give a sufficient compensation effect. Accordingly, even when the two adjacent sub-pixels 2 are symmetrical to each other, the compensation effect achieved by the two adjacent sub-pixels in total is small. In contrast, Example 2 causes large misalignment between the two substrates: Thus, when the light-shielding member 4 is enlarged around each TFT 13 and the sub-pixel apertures 35L and 35R each have a bend shape, each sub-pixel 2 fails to give a sufficient compensation effect. Meanwhile, the compensation effect achieved by the two adjacent sub-pixels 2 in total is increased. In addition, the structure in which-the two adjacent sub-pixels 2 are line symmetrical to each other further increases the total compensation effect.

### EXAMPLE 3

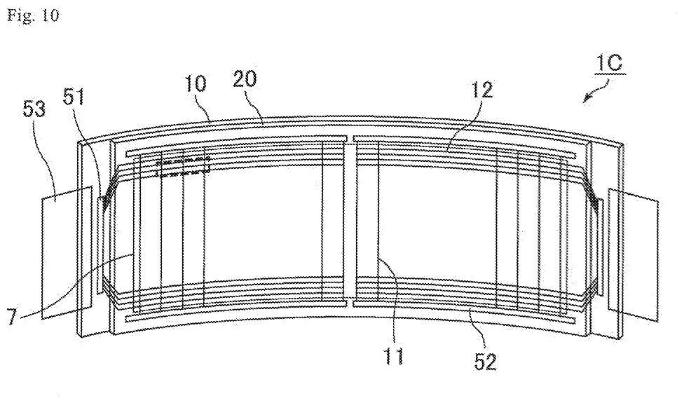

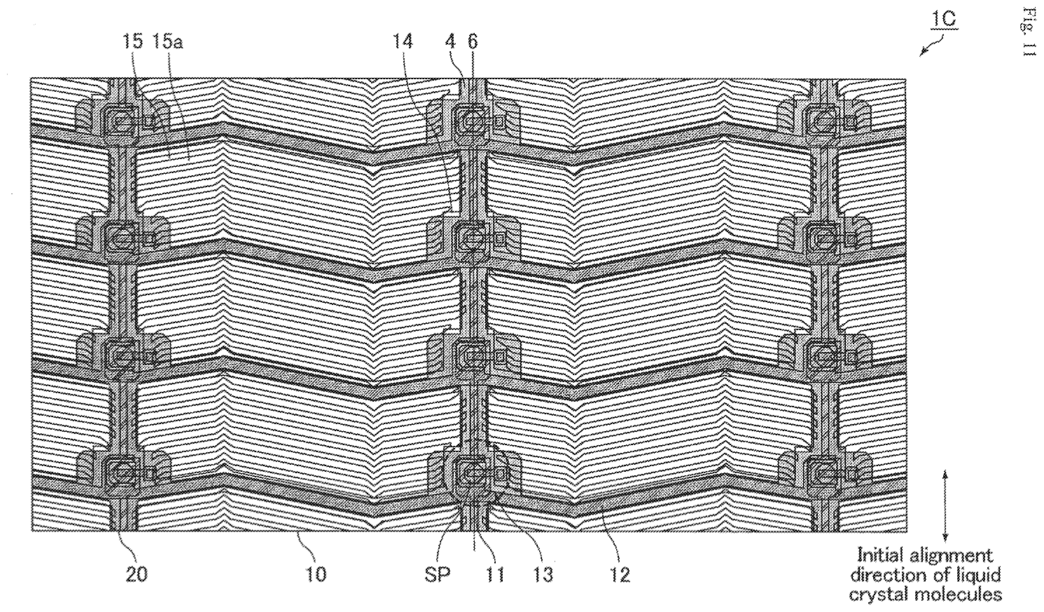

FIG. 10 is a schematic perspective view of a liquid crystal display device of Example 3. FIG. 11 is a schematic plan view of the liquid crystal display device of Example 3. While the liquid crystal display device 1A of Example 1 and the liquid crystal display device 18 of Example 2 include horizontal stripe sub-pixels, a liquid crystal display device 1C of Example 3 includes vertical stripe sub-pixels. The liquid crystal display device 1C of Example 3 has the same structure as the liquid crystal display device 1B of Example 2 except for the formation of the gate lines 11 and the data lines 12, the number of bus lines, and the circuit therearound.

The liquid crystal display device 1C of Example 3 is a curved display as shown in FIG. 10. The liquid crystal display device 1C of Example 3 had a size of 33 inch and a variant shape (3840×1080 sub-pixels, which correspond to the size two full high definition (FHD) screens are horizontally arranged) and included 3840 gate lines 11 and 1080×3 data lines 12. The sub-pixel pitch was 70 μm×210 μm.

The liquid crystal display device 1C of Example 3 had a display region 7 having a length in the long side direction of about 806 mm. The sub-pixels 2 were arranged such that the long side direction of the sub-pixels 2, i.e., the color alignment direction 5c, corresponded to the long side direction of the display region 7.

In the liquid crystal display device 1C of Example 3, the display region 7 had a curvature radius of 2000 mm, and the first substrate 10 and the second substrate 20 each had a thickness of 0.1 mm. The liquid crystal display device 1C of Example 3 was curved in the long side direction with the second substrate 20 made inside (viewer's side).

In the liquid crystal display device 1C of Example 3, the color filters 21 disposed in the second substrate 20 were formed in a stripe pattern in the curved direction of the display region 7. The liquid crystal display devices 1A and 1B of Examples 1 and 2 include horizontal stripe sub-pixels in which the lengths of the sub-pixels 2 are longer in the direction the gate lines 11 extend than in the direction the data lines 12 extend. In contrast, the liquid crystal display device 1C of Example 3 includes vertical stripe sub-pixels in which the lengths of the sub-pixels 2 are longer in the direction the data lines 12 extend than in the direction the gate lines 11 extend. In the liquid crystal display device 1C of Example 3, the data lines 12 each extended, having left and right bends to form a zigzag pattern, and the gate lines 11 each extended straight upward and downward. The common electrode 15 was provided with the apertures 15a each extending in the direction parallel to the data lines 12.

The first substrate 10 and the second substrate 20 of the liquid crystal display device 1C of Example 3 were assumed to be bonded with a misalignment amount of 5 μm in the up or, down direction and/or 20 μm in the left or right direction. The expression up or down direction herein corresponds to the direction perpendicular to the curved direction of the display region 7, and the expression left or right direction herein corresponds to the curved direction of the display region 7.

As shown in FIG. 10, in the liquid crystal display device 1C of Example 3, a data line drive circuit (source driver) 51 and flexible printed circuits (FPC) 53 for inputting a signal into the data line drive circuit 51 and a gate line drive circuit (gate driver) 52 were substantially equally disposed on the left and right sides of the display region 7. The data line drive circuit 51 was formed by mounting a semiconductor chip on the first substrate 10. The gate line drive circuit 52 was monolithically formed on the first substrate 10. In other words, the liquid crystal display device 10 of Example 3 had no external mounting member following the curved shape of the display region 7.

Although not shown in FIG. 10 and FIG. 11, in the liquid crystal display device 1C of Example 3, a sealant for bonding the first substrate 10 and the second substrate 20 together was also symmetrically formed. This structure was found to prevent misalignment, which is caused when the first substrate 10 and the second substrate 20 were bonded together, from significantly increasing in a certain portion in the display region 7.

Each and every detail described for the above embodiment of the present invention shall be applied to all the aspects of the present invention.

### [Additional Remarks]

An aspect of the present invention may relate to the liquid crystal display devices 1A, 1B, and 1C, each including: the first substrate 10 including the sub-pixel electrode 14 and the common electrode 15; the liquid crystal layer 30 containing the liquid crystal molecules 30a; the second substrate 20 that faces the first substrate 10 through the liquid crystal layer 30 and includes the light-shielding member 4; the multiple pixels 3 each including the multiple sub-pixels 2 each including at least one of the first liquid crystal domains 31, 31a, 31b, and 31c and at least one of the second liquid crystal domains 32, 32a, 32b, and 32c, where the liquid crystal molecules 30a align in different directions from each other with voltage applied; and the color filters 21 of different colors disposed for the respective sub-pixels 2, the first liquid crystal domains 31, 31a, 31b, and 31c and the second liquid crystal domains 32, 32a, 32b, and 32c being arranged in the color alignment direction 5c that is a direction the color filters 21 of the same color align, the light-shielding member 4 including the boundary light-shielding portion 4a at a position corresponding to the boundary between two sub-pixels 2 adjacent in the color alignment direction 5c, a first sub-pixel of the two sub-pixels 2 including two first liquid crystal domains 31a and 31b located at the respective ends of the sub-pixel in the color alignment direction 5c and one second liquid crystal domain 32a between the two first liquid crystal domains 31a and 31b, a second sub-pixel of the two sub-pixels 2 including two second liquid crystal domains 32b and 32c located at the respective ends of the sub-pixel in the color alignment direction 5c and one first liquid crystal domain 31c between the two second liquid crystal domains 32b and 32c.

As mentioned above, the light-shielding member 4 includes the boundary light-shielding portion 4a at a position corresponding to the boundary between two sub-pixels adjacent in the color alignment direction 5c. The first sub-pixel, which is one of the two sub-pixels 2, includes two first liquid crystal domains 31a and 31b located at respective ends of the sub-pixel in the color alignment direction 5c and a second liquid crystal domain 32a between the two first liquid crystal domains 31a and 31b. Thereby, even when the first substrate 10 and the second substrate 20 are bonded with misalignment to cause the boundary light-shielding portion 4a to be displaced in a direction at least including the color alignment direction 5c as a component, at least the second liquid crystal domain 32a between the first liquid crystal domains 31a and 31b is less likely to be influenced by the change in aperture ratio caused by the displacement of the boundary light-shielding portion 4a.

Although the two first liquid crystal domains 31a and 31b are located at the respective ends of the sub-pixel 2 and are thus likely to be influenced by the displacement of the boundary light-shielding portion 4a, the two first liquid crystal domains 31a and 31b compensate for their aperture ratios each other. Specifically, in the case where the boundary light-shielding portion 4a is displaced in the above direction, the aperture ratio of one first liquid crystal domain 31a decreases while the aperture ratio of the other first liquid crystal domain 31b increases. Thereby, even when the boundary light-shielding portion 4a is displaced in the above direction, this structure can suppress the change in difference between the aperture ratio of the two first liquid crystal domains 31a and 31b (aperture ratio of the region encompassing the two first liquid crystal domains 31a and 31b) and the aperture ratio of the second liquid crystal domain 32a, and thereby giving a good effect of color shift compensation in each sub-pixel 2.

Similarly in the second sub-pixel, which is the other of the two sub-pixels 2, the same mechanism can give a good effect of color shift compensation in each sub-pixel 2.

The first sub-pixel includes the two first liquid crystal domains 31a and 31b located at respective ends of the sub-pixel 2 in the color alignment direction 5c and the second liquid crystal domain 32a between the two first liquid crystal domains 31a and 31b. The second sub-pixel includes the two second liquid crystal domains 32b and 32c located at respective ends of the sub-pixel 2 in the color alignment direction 5c and the first liquid crystal domain 31c between the two second liquid crystal domains 32b and 32c.

These two sub-pixels 2 in total include two first liquid crystal domains 31a and 31b, which are likely to be influenced by the displacement of the light-shielding member 4, one first liquid crystal domain 31c, which is less likely to be influenced by the displacement of the light-shielding member 4, two second liquid crystal domains 32b and 32c, which are likely to be influenced by the displacement of the light-shielding member 4, and one second liquid crystal domain 32c, which is less likely to be influenced by the displacement of the light-shielding member 4.

Thereby, even when the light-shielding member 4 is displaced in the color alignment direction 5c, this structure can suppress the change in difference between the aperture ratio of the three first liquid crystal domains 31a, 31b, and 31c (aperture ratio of the region encompassing the three first liquid crystal domains 31a, 31b, and 31c) and the aperture ratio of the three second liquid crystal domains 32a, 32b, and 32c (aperture ratio of the region encompassing the three second liquid crystal domains 32a, 32b, and 32c). The two sub-pixels 2 adjacent in the color alignment direction 5c thus can achieve a better effect of color shift compensation.

The liquid crystal display devices 1A, 1B, and 1C may each include a curved display region 7. Although this structure tends to increase the displacement of the light-shielding member 4, the aspect of the present invention can effectively suppress color shift.

The display region 7 may be curved in the color alignment direction 5c. This structure can give a good effect of color shift compensation while suppressing the reduction in aperture ratio even when the light-shielding member 4 is disposed between the color filters 21 of different colors for preventing color mixing.

In the first sub-pixel, a total area of sub-pixel apertures 33a and 33b of the two first liquid crystal domains 31a and 31b may equal a total area of the sub-pixel aperture 34a of the second liquid crystal domain 32a, and in the second sub-pixel, a total area of sub-pixel apertures 34b and 34c of the two second liquid crystal domains 32b and 32c may equal a total area of the sub-pixel aperture 33c of the first liquid crystal domain 31c. This structure can give a still better effect of color shift compensation in each sub-pixel 2.

The sub-pixel apertures 35L and 35R of the two sub-pixels 2 may be line symmetrical to each other about a straight line 6 running between the two sub-pixels 2, and with voltage applied, alignment directions of the liquid crystal molecules 30a in the first sub-pixel 2 may be line symmetrical to alignment directions of the liquid crystal molecules 30a in the second sub-pixel 2 about the straight line 6 running between the two sub-pixels. This structure enables, in consideration of two adjacent sub-pixels 2 in the color alignment direction 5c in total, the change in aperture ratio of the first liquid crystal domains 31 caused by the misalignment between the two substrates to come close to the change in aperture ratio of the second liquid crystal domains 32 caused by the misalignment therebetween. Thus, this structure can effectively suppress the change in difference between the aperture ratio of the first liquid crystal domains 31 and the aperture ratio of the second liquid crystal domains caused by the above misalignment, and thereby giving a still better effect of color shift compensation.

The first substrate 10 may further include a thin-film transistor 13 connected to the sub-pixel electrode 14, the light-shielding member 4 may include a channel light-shielding portion 4b that covers a channel 13e of the thin-film transistor 13, and in the color alignment direction 5c, a distance from an edge 13f of the channel 13e to an edge 4c of the channel light-shielding portion 4b located outside the edge 13f maybe 20 μm or longer. This structure can prevent external light from being incident on the channel 13e of the thin-film transistor 13 and achieves a good effect of color shift compensation at the same time even when the light-shielding member 4 is significantly displaced.

One of the first liquid crystal domain 31 and the second liquid crystal domain 32 may include the liquid crystal molecules 30a that rotate in a clockwise direction with voltage applied, and the other of the first liquid crystal domain 31 and the second liquid crystal domain 32 may include the liquid crystal molecules 30a that rotate in a counterclockwise direction with voltage applied.

### REFERENCE SIGNS LIST

1A, 1B, 10, 101A, 101B: Liquid crystal display device
2, 102: Sub-pixel
2L, 102L: Left sub-pixel
2R, 102R: Right sub-pixel
3: Pixel
4, 104: Light-shielding member
4a, 104a: Boundary light-shielding portion
4b, 104b: Channel light-shielding portion
4c, 104c: Edge of channel light-shielding portion
5a, 105a: First direction
5b, 105b: Second direction
5c, 105c: Color alignment direction
6: Straight line
7: Display region
10: First substrate
10a, 20a: Insulating substrate
11, 111: Gate lines
12, 112: Data lines
13, 113: Thin-film transistor (TFT)
13a: Gate electrode
13b: Source electrode
13c: Drain electrode
13d, 113d: Semiconductor layer
13e, 113e: Channel
13f, 113f: Edge of channel
14: Sub-pixel electrode
15, 115: Common electrode
15a, 115a: Aperture
20: Second substrate
21: Color filter
21R: Red color filter
21G: Green color filter
21B: Blue color filter
22: Overcoat layer
30: Liquid crystal layer
30a, 130a: Liquid crystal molecule
31, 31a, 31b, 31c, 131, 131a, 131b: First liquid crystal domain
32, 32a, 32b, 32c, 132, 132a, 132b: Second liquid crystal domain
33a, 33b, 33c, 133a, 133b: Sub-pixel aperture of first liquid crystal domain
34a, 34b, 34c, 134a, 134b: Sub-pixel aperture of second liquid crystal domain
35L, 35R: Sub-pixel aperture
41: First insulating film
42: Second insulating film
42a: Contact hole
43: Third insulating film
51: Data line drive circuit
52: Gate line drive circuit
53: Flexible printed circuit
A, AA: Distance from the edge of channel to the edge of channel light-shielding portion located outside the edge
SP: Columnar spacer

1. A liquid crystal display device comprising:
a first substrate provided with a sub-pixel electrode and a common electrode;
a liquid crystal layer containing liquid crystal molecules;
a second substrate that faces the first substrate through the liquid crystal layer and includes a light-shielding member;
multiple pixels each including multiple sub-pixels each including at least one first liquid crystal domain and at least one second liquid crystal domain, where the liquid crystal molecules align in different directions from each other with voltage applied; and
color filters of different colors disposed for the respective sub-pixels,
the first liquid crystal domains and the second liquid crystal domains being arranged in a color alignment direction that is a direction the color filters of a same color align,
the light-shielding member including a boundary light-shielding portion at a position corresponding to a boundary between two sub-pixels adjacent in the color alignment direction,
a first sub-pixel of the two sub-pixels including two first liquid crystal domains located at respective ends of the sub-pixel in the color alignment direction and a second liquid crystal domain between the two first liquid crystal domains,
a second sub-pixel of the two sub-pixels including two second liquid crystal domains located at respective ends of the sub-pixel in the color alignment direction and a first liquid crystal domain between the two second liquid crystal domains.

2. The liquid crystal display device according to claim 1,
wherein the liquid crystal display device includes a curved display region.

3. The liquid crystal display device according to claim 2,
wherein the display region is curved in the color alignment direction.

4. The liquid crystal display device according to claim 1,
wherein in the first sub-pixel, a total area of sub-pixel apertures of the two first liquid crystal domains equals a total area of a sub-pixel aperture of the second liquid crystal domain, and
in the second sub-pixel, a total area of sub-pixel apertures of the two second liquid crystal domains equals a total area of a sub-pixel aperture of the first liquid crystal domain.

5. The liquid crystal display device according to claim 1,
wherein the sub-pixel apertures of the two sub-pixels are line symmetrical to each other about a straight line running between the two sub-pixels, and
with voltage applied, alignment directions of the liquid crystal molecules in the first sub-pixel are line symmetrical to alignment directions of the liquid crystal molecules in the second sub-pixel about the straight line running between the two sub-pixels.

6. The liquid crystal display device according to claim 1,
wherein the first substrate further includes a thin-film transistor connected to the sub-pixel electrode,
the light-shielding member includes a channel light-shielding portion that covers a channel of the thin-film transistor, and
in the color alignment direction, a distance from an edge of the channel to an edge of the channel light-shielding portion located outside the edge of the channel is 20 μm or longer.

7. The liquid crystal display device according to claim 1,
wherein with voltage applied, the liquid crystal molecules rotate in a clockwise direction in the first liquid crystal domains and in a counterclockwise direction in the second liquid crystal domains, or the liquid crystal molecules rotate in a counterclockwise direction in the first liquid crystal domains and in a clockwise direction in the second liquid crystal domains.
